(19) United States
(12) Patent Application Publication
(10) Pub. No.: US 2013/0226805 A1
(43) Pub. Date: Aug. 29, 2013

(54) PROTECTION FOR EXCEEDING A CREDIT THRESHOLD

(71) Applicant: Bank of America Corporation, (US)

(72) Inventors: Maura Louise Griffin, Atlanta, GA (US); Harry Guiton Lomax, Charlotte, NC (US)

(73) Assignee: BANK OF AMERICA CORPORATION, Charlotte, NC (US)

(21) Appl. No.: 13/841,605

(22) Filed: Mar. 15, 2013

Related U.S. Application Data
(63) Continuation-in-part of application No. 12/752,251, filed on Apr. 1, 2010.

(51) Int. Cl. G06Q 20/40

(52) U.S. Cl. CPC G06Q 20/409
USPC 705/44

(57) ABSTRACT

In general terms, embodiments of the present invention relate to methods and apparatuses for providing protection for exceeding a credit threshold. In embodiments of the present invention are configured to: (a) receive a request to authorize a transaction involving a credit account, (b) determine that the credit account will exceed the credit threshold as a result of the transaction, and (c) authorize the transaction based at least partially on a determination that the credit account has protection through a source account for exceeding the credit threshold. As another example, other embodiments of the present invention are additionally and/or alternatively configured to: (a) determine that a credit account has exceeded, or will exceed the credit threshold as a result of a transaction, and (b) transfer funds from a source account to the credit account in an amount sufficient to offset the amount which exceeds the credit threshold.

### CROSS-REFERENCE TO RELATED APPLICATIONS

The present application is a continuation-in-part application of, and claims priority to, U.S. patent application Ser. No. 12/752,251, which was filed on Apr. 1, 2010, and is titled “Over Limit Protection,” and is incorporated by reference herein in its entirety.

### FIELD

In general terms, embodiments of the present invention relate to methods and apparatuses for providing protection for exceeding a credit threshold.

### BACKGROUND

Financial institution customers are constantly looking for new and useful ways to protect themselves against the effects of occasionally exceeding credit thresholds and/or accidentally making financial mistakes. This is particularly so given that most of today's financial institution customers have several different financial accounts, and the outcomes associated with, for example, forgetting to transfer funds, missing an account payment, causing an account to exceed the available funds, spending beyond a maximum credit threshold, and the like, can result in serious sanctions, such as, for example, substantial payments, interest rate increases, and/or the like. In some cases, it can be embarrassing and/or frustrating to be involved in a transaction that is declined due to unavailable funds or credit. Accordingly, there is a need to provide methods and apparatuses that help financial institution customers mitigate and/or avoid the outcomes associated with occasionally exceeding maximum credit thresholds and/or accidentally making financial mistakes.

### SUMMARY OF SELECTED EMBODIMENTS OF THE PRESENT INVENTION

In general terms, embodiments of the present invention relate to methods and apparatuses for providing protection for exceeding the maximum credit threshold. For example, some embodiments of the present invention are embodied as an apparatus that includes: (a) a communication interface configured to receive a request to authorize a transaction involving a credit account; and (b) a processor operatively connected to the communication interface and configured to: (i) determine that the credit account will exceed a credit threshold associated with the credit account as a result of the transaction; and (ii) authorize the transaction based at least partially on a determination that the credit account has protection through a source account for exceeding the credit threshold.

In some embodiments of the apparatus, the amount which exceeds the credit threshold includes the difference between an amount of one or more responsibilities incurred by the credit account as a result of the transaction and an amount of credit available to the credit account immediately prior to the transaction. In some embodiments, the source account includes two or more source accounts, and the processor is configured to transfer funds from the two or more source accounts to the credit account in accordance with one or more user selections. In some embodiments of the apparatus, the processor is also configured to transfer funds from the source account to the credit account in an amount sufficient to offset the amount that exceeds the credit threshold. For example, in some embodiments, the processor is configured to transfer offsetting funds from the source account to the credit account before the amount that exceeds the credit threshold is assessed to the credit account.

In some embodiments of the apparatus, the processor is configured to authorize the transaction based at least partially on: (a) the determination that the credit account has protection through the source account for exceeding the credit threshold, and (b) a determination that the source account includes sufficient funds to offset the amount that exceeds the credit threshold. In other embodiments, the processor is configured to authorize the transaction based at least partially on: (a) the determination that the credit account has protection through the source account for exceeding a credit threshold associated with the credit account, (b) a determination that the source account does not include enough funds to offset the amount that exceeds the credit threshold, and (c) a determination that a holder of the credit account has opted in to a protection service provided by a creditor associated with the credit account, wherein the protection service provides protection for exceeding the credit threshold. In some embodiments, the determination that the holder of the credit account has opted in to the protection service is based at least partially on the determination that the credit account has protection through the source account for exceeding the credit threshold. Further, in some embodiments of the apparatus, the protection service is provided in accordance with the Credit CARD Act of 2009.

In some embodiments of the apparatus, the processor is further configured to apply a service payment to at least one of the source account or the credit account. In some embodiments, the processor is configured to authorize the transaction based at least partially on: (a) the determination that the credit account has protection through the source account for exceeding a credit threshold associated with the credit account, and (b) a determination that the amount by which the credit threshold is exceeded is less than a predetermined amount. In still other embodiments of the apparatus, the communication interface is configured to receive a second request to authorize a second transaction involving a second credit account, and the processor is configured to: (a) determine that the second credit account will exceed a second credit threshold associated with the second credit account as a result of the second transaction; and (b) decline the second transaction based at least partially on: (i) a determination that the second credit account has protection through a second source account for exceeding the second credit threshold, (ii) a determination that the second source account does not include enough funds to offset the second amount which exceeds the credit threshold, and (iii) a determination that a second holder of the second credit account has not opted in to an protection service provided by a second creditor associated with the second credit account.

In some embodiments of the apparatus, the communication interface is further configured to receive a second request to authorize a second transaction involving a second credit account, and where the processor is further configured to: (a) determine that the second credit account will exceed a second credit threshold associated with the second credit account as a result of the second transaction; (b) determine that the second credit account has protection through a second source account for exceeding the second credit threshold; and (c) decline the second transaction based at least partially on at least one of: (i) a determination that the amount by which the second threshold is exceeded is greater than a predetermined amount, or (ii) a determination that the second transaction occurs outside of a predetermined geographic area. In some embodiments, the processor is configured to decline the second transaction based at least partially on a user-selected parameter. In some embodiments of the apparatus, the processor is configured to generate a notification regarding the credit threshold being exceeded, the communication device is configured to transmit the notification to a device accessible to the consumer while the transaction is still pending, the communication device is configured to receive a response to the notification, and the processor is configured to authorize the transaction based at least partially on the response.

As another example, some embodiments of the present invention are embodied as a method that includes: (a) receiving a request to authorize a transaction involving a credit account; (b) determining that the credit account will exceed a credit threshold associated with the credit account as a result of the transaction; and (c) authorizing, using a processor, the transaction based at least partially on a determination that the credit account has protection through a source account for exceeding the credit threshold.

As still another example, some embodiments of the present invention are embodied as an apparatus that includes: (a) a communication interface configured to receive requests to authorize transactions, where each of the transactions involves a credit account that will exceed a credit threshold associated with the credit account if the transaction is authorized; and (b) a processor operatively connected to the communication interface and configured to: (i) authorize a first group of the transactions based at least partially on a determination that, for each transaction in the first group, the credit account has protection through a source account for exceeding the credit threshold; (ii) authorize a second group of the transactions based at least partially on a determination that, for each transaction in the second group, the credit account is held by a holder that has opted in to an protection service provided by a creditor associated with the credit account, wherein the protection service provides protection for exceeding the credit threshold; and (iii) decline a third group of the transactions based at least partially on: (A) a determination that, for each transaction in the third group, the credit account does not have protection through a source account for exceeding the credit threshold, and (B) a determination that, for each transaction in the third group, the credit account is held by a holder that has not opted in to an protection service provided by a creditor associated with the credit account, wherein the protection service provides protection for exceeding a credit threshold.

In some embodiments of this apparatus, the processor is also configured to, for each transaction in the first group, transfer funds from the source account to the credit account in an amount sufficient to offset the amount which exceeds the credit threshold. In some embodiments, the processor is additionally or alternatively configured to: (a) for each transaction in the first group, apply a protection service payment for exceeding the credit threshold to at least one of the source account or the credit account; and (b) for each transaction in the second group, apply a payment for exceeding the available funds to the credit account, where the payment applied for each transaction in the second group is greater than the protection payment applied for each transaction in the first group.

In some embodiments of the apparatus, the processor is configured to authorize the first group of the transactions based at least partially on: (a) the determination that, for each transaction in the first group, the credit account has protection through a source account for exceeding a credit threshold associated with the credit account, and (b) a determination that, for each transaction in the first group, the source account includes sufficient funds to offset the amount which exceeds the credit threshold. In some embodiments, the processor is configured to authorize the second group of the transactions based at least partially on: (a) the determination that, for each transaction in the second group, the credit account is held by a holder that has opted in to a protection service provided by a creditor associated with the credit account, wherein the protection service provides protection for exceeding the credit threshold, (b) a determination that, for each transaction in the second group, the credit account has protection through a source account for exceeding a credit threshold associated with the credit account, and (c) a determination that, for each transaction in the second group, the source account does not include enough funds to offset the amount which exceeds the credit threshold.

In some embodiments, the determination that, for each transaction in the second group, the credit account is held by a holder that has opted in to a protection service is based at least partially on the determination that, for each transaction in the second group, the credit account has protection through a source account for exceeding a credit threshold associated with the credit account. In some embodiments of the apparatus, the protection service is provided in accordance with the Credit CARD Act of 2009. Also, in some embodiments of the apparatus, the processor is further configured to decline a fourth group of the transactions based at least partially on: (a) a determination that, for each transaction in the fourth group, the credit account has protection through a source account for exceeding a credit threshold associated with the credit account, (b) a determination that, for each transaction in the fourth group, the source account does not include enough funds to offset the amount which exceeds the credit threshold, and (c) a determination that, for each transaction in the fourth group, the credit account is held by a holder that has not opted in to a protection service provided by a creditor associated with the credit account, wherein the protection service provides protection for exceeding the credit threshold.

As yet another example, some embodiments of the present invention are embodied as a method that includes: (a) receiving requests to authorize transactions, where each of the transactions involves a credit account that will exceed a credit threshold associated with the credit account if the transaction is authorized; (b) authorizing, using a processor, a first group of the transactions based at least partially on a determination that, for each transaction in the first group, the credit account has protection through a source account for exceeding a credit threshold associated with the credit account; (c) authorizing, using a processor, a second group of the transactions based at least partially on a determination that, for each transaction in the second group, the credit account is held by a holder that has opted in to a protection service provided by a creditor associated with the credit account, wherein the protection service provides protection for exceeding the credit threshold; and (d) declining, using a processor, a third group of the transactions based at least partially on: (i) a determination that, for each transaction in the third group, the credit account does not have protection through a source account for exceeding a credit threshold associated with the credit account, and (ii) a determination that, for each transaction in the third group, the credit account is held by a holder that has not opted in to a protection service provided by a creditor associated with the credit account, wherein the protection service provides protection for exceeding the credit threshold.

As another example, some embodiments of the present invention are embodied as a computer program product that includes a non-transitory computer-readable medium having computer-executable program code portions stored therein. In some embodiments, the computer-executable program code portions include: (a) a first program code portion configured to receive requests to authorize transactions, where each of the transactions involves a credit account that will exceed a credit threshold associated with the credit account if the transaction is authorized; (b) a second program code portion configured to authorize a first group of the transactions based at least partially on a determination that, for each transaction in the first group, the credit account has protection through a source account for exceeding a credit threshold associated with the credit account; (c) a third program code portion configured to authorize a second group of the transactions based at least partially on a determination that, for each transaction in the second group, the credit account is held by a holder that has opted in to a protection service provided by a creditor associated with the credit account, where the protection service provides protection for exceeding the credit threshold; and (d) a fourth program code portion configured to decline a third group of the transactions based at least partially on a determination that, for each transaction in the third group, the credit account: (i) does not have protection through a source account for exceeding a credit threshold associated with the credit account, and (ii) is held by a holder that has not opted in to a protection service provided by a creditor associated with the credit account, where the protection service provides protection for exceeding the credit threshold.

As still another example, some embodiments of the present invention are embodied as an apparatus that includes a processor configured to: (a) determine that a credit account has exceeded, or will exceed the credit threshold as a result of a transaction; and (b) transfer funds from a source account to the credit account in an amount sufficient to offset the amount which exceeds the credit threshold.

As a further example, some embodiments of the present invention are embodied as a method that includes: (a) determining that a credit account has exceeded, or will exceed the credit threshold as a result of a transaction; and (b) transferring funds, using a processor, from a source account to the credit account in an amount sufficient to offset the amount which exceeds the credit threshold.

### BRIEF DESCRIPTION OF THE DRAWINGS

Having thus described embodiments of the present invention in general terms, reference will now be made to the accompanying drawings, wherein:

FIG. 1 is a flow diagram illustrating a general process flow of an apparatus for providing protection for exceeding a credit threshold, in accordance with an embodiment of the present invention;

FIG. 2 is a flow diagram illustrating a general process flow of an apparatus for providing protection for exceeding a credit threshold, in accordance with an embodiment of the present invention;

FIG. 3 is a flow diagram illustrating a more-detailed process flow of an apparatus for providing protection for exceeding a credit threshold for a credit card account, in accordance with an embodiment of the present invention;

FIG. 4 is a block diagram illustrating technical components of a system for providing protection for exceeding a credit threshold, in accordance with an embodiment of the present invention; and

FIG. 5 is a mixed block and flow diagram of a system for providing protection for exceeding a credit threshold, in accordance with an embodiment of the present invention.

### DETAILED DESCRIPTION OF EMBODIMENTS OF THE PRESENT INVENTION

Embodiments of the present invention will now be described more fully hereinafter with reference to the accompanying drawings, in which some, but not all, embodiments of the present invention are shown. Indeed, the present invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and/or vice versa, unless explicitly stated otherwise. Also, as used herein, the term “a” and/or “an” shall mean “one or more,” even though the phrase “one or more” is also used herein. Like numbers refer to like elements throughout.

As will be appreciated by one of ordinary skill in the art in view of this disclosure, the present invention may be embodied as an apparatus (including, for example, a system, machine, device, computer program product, and/or the like), as a method (including, for example, a business process, computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory and/or non-transitory computer-readable medium (e.g., a memory, and the like) that can direct a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator- and/or human-implemented steps in order to carry out an embodiment of the present invention.

Further, although many of the embodiments of the present invention described herein are generally described as involving a “financial institution,” other embodiments of the present invention may involve one or more persons, organizations, businesses, and/or other entities that take the place of, and/or work in conjunction with, the financial institution to implement one or more portions of one or more of the embodiments described and/or contemplated herein.

It will be understood that the phrase “amount which exceeds the credit threshold,” as used herein, generally refers to the difference between: (a) the total amount of one or more purchases, draws, service payments, payments, balance transfers, and/or other financial obligations (collectively referred to herein as “responsibilities” for simplicity) incurred, or that will be incurred, by a credit account as a result of a transaction, and (b) the amount of credit available to the credit account immediately prior to the transaction. For example, if a credit account has $500 in available credit immediately before the credit account is used to make a $600 purchase, then it will be understood that the credit account will exceed the credit threshold in the amount of $100 as a result of the purchase. Additionally or alternatively, in some embodiments, the phrase “amount which exceeds the credit threshold” generally refers to the difference between an account balance for the credit account and a maximum credit threshold (sometimes referred to as “credit line”) associated with the credit account. For example, if a credit account has a $5,000 maximum credit threshold and a $5,300 account balance, then it will be understood that the credit account has exceeded the credit threshold by one or more amounts totaling $300.

It will also be understood that the phrase “transaction which causes the credit threshold to be exceeded,” as used herein, generally refers to any past, present, future, initiated, pending, and/or completed transaction involving a credit account that results in the credit account exceeding the available funds or credit threshold. The term “transaction,” as used herein, generally refers to an event involving a purchase, service payment, payment, draw, balance transfer, exchange, and/or the like. It will also be understood that the phrase “protection,” as used herein, generally refers to the concept of using funds from a financial account (referred to herein as a “source” account) to offset (e.g., sweep, pay off, prepay, cover, cancel out, negate, make up for, and the like) one or more amounts which exceed the available balance or credit threshold, and/or that will be incurred, by a credit account as a result of one or more transactions which cause the credit threshold to be exceeded. In such cases, it will be understood that the source account provides protection to the credit account, or in other words, the credit account has protection through the source account for exceeding a credit threshold associated with the credit account.

In general terms, embodiments of the present invention relate to methods and apparatuses for providing protection for exceeding a credit threshold associated with the credit account. For example, some embodiments of the present invention are configured to: (a) determine that a credit account has exceeded, or will exceed the credit threshold as a result of a transaction; and (b) transfer funds from a source account to the credit account in an amount sufficient to offset the amount which exceeds the credit threshold. As another example, some embodiments of the present invention are additionally or alternatively configured to: (a) receive a request to authorize a transaction involving a credit account, (b) determine that the credit account will exceed a credit threshold associated with the credit account as a result of the transaction; and (c) authorize the transaction based at least partially on a determination that the credit account has protection through a source account for exceeding a credit threshold associated with the credit account.

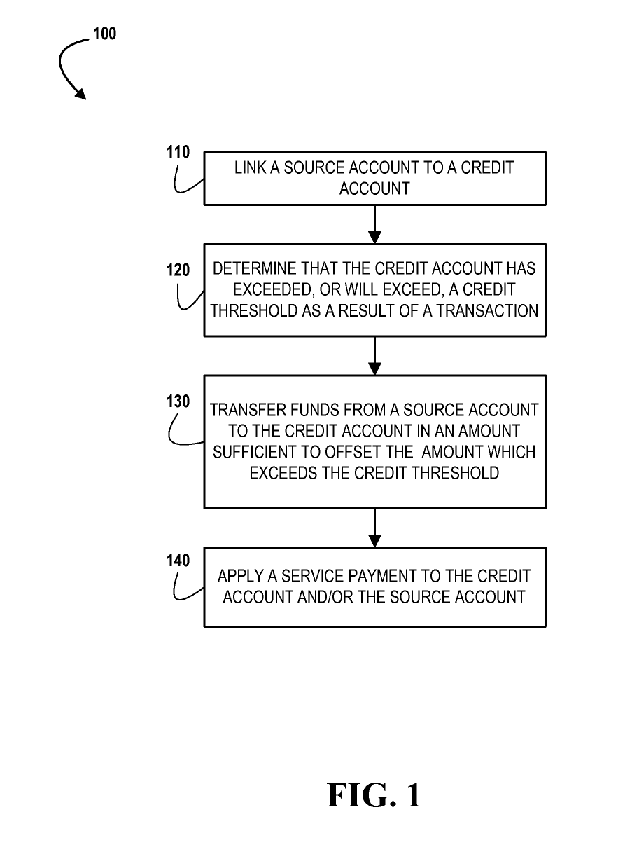

Referring now to FIG. 1, a general process flow 100 of an apparatus for providing protection for exceeding a credit threshold associated with the credit account is provided, in accordance with an embodiment of the present invention. As represented by the block 110, the apparatus is configured to link a source account to a credit account. As represented by the block 120, the apparatus is also configured to determine that the credit account has exceeded, or will exceed the credit threshold as a result of a transaction (sometimes, for simplicity, collectively referred to herein as “making a determination”). As represented by the block 130, the apparatus is also configured to transfer funds from the source account to the credit account in an amount sufficient to offset the amount which exceeds the credit threshold (sometimes, for simplicity, collectively referred to herein as “making an offsetting funds transfer” and/or “transferring offsetting funds”). As represented by the block 140, in some embodiments, the apparatus is further configured to apply a protection service payment to the credit account and/or to the source account.

Regarding the block 110, it will be understood that the apparatus can be configured to link the source account to the credit account in any way. For example, in some embodiments, the source account is linked to the credit account by electronically and/or communicably connecting the source account to the credit account, such that, for example, funds in the source account may be transferred to the credit account and/or vice versa. In some embodiments, by linking the source account to the credit account, the apparatus having the process flow 100 configures the source account to automatically offset one or more amounts that have exceeded the credit threshold, and/or that will be incurred, by the credit account.

It will also be understood that the source account referred to in the process flow 100 can include any type of financial account. For example, in some embodiments, the source account includes a deposit account, credit account, investment account, checking account, savings account, money market account, certificate of deposit account, credit card account, line of credit (LOC) account, home equity line of credit (HELOC) account, brokerage account, margin account, sweep account, store credit account, and/or any other type of financial account. It will further be understood that the credit account referred to in the process flow 100 can include any type of credit account. For example, in some embodiments, the credit account includes a credit card account, LOC account, HELOC account, store credit account, and/or any other type of credit account. In some embodiments, the source account and the credit account both include credit accounts, such as, for example, where the source account and the credit account are both credit card accounts, where the source account is a HELOC account and the credit account is a credit card account, and/or the like.

It will also be understood that the source account and the credit account can each include any number of accounts. For example, in some embodiments, the credit account is a credit card account, and the source account includes a checking account and a savings account, such that both the checking account and the savings account are linked to the credit account and are configured to offset one or more amounts that have exceeded the credit threshold, and/or that will be incurred, by the credit account. As another example, in some embodiments, the source account is a checking account, and the credit account includes a credit card account and a HELOC account, such that the checking account is linked to both the credit card account and the HELOC account and is configured to offset one or more amounts that have exceeded the credit threshold, and/or that will be incurred, by the credit card account and/or by the HELOC account.

It will also be understood that the source account and the credit account may be determined, identified, inputted, defined, and/or otherwise selected (collectively referred to herein as “selected” or “select” for simplicity) for linking in any way. For example, in some embodiments, the apparatus having the process flow 100 is configured to prompt and/or enable a user (e.g., a holder of the source account and/or the credit account, a financial institution employee, and the like) to select, e.g., via the customer's online and/or mobile banking account, the source account and the credit account for linking. Also, in some embodiments, the apparatus having the process flow 100 is configured to determine, and/or recommend to a user, the source account and the credit account for linking. For example, in some embodiments, the apparatus is configured to access a financial institution customer's online and/or mobile banking account to determine the number and types of accounts held by the customer, how frequently those accounts are used (e.g., by analyzing the transaction history of those accounts), how well those accounts are funded, and the like, and then based at least partially on that information, automatically select two or more accounts for linking and/or recommend to the customer which accounts the customer should select for linking.

Further, it will be understood that, in some embodiments, the source account, the credit account, and/or the apparatus having the process flow 100 are controlled, serviced, managed, operated, and/or maintained (collectively referred to herein as “maintained” for simplicity) by a single financial institution. For example, in some embodiments, the apparatus is maintained by a bank, the source account is maintained by the bank, the credit account is maintained by the bank, and the apparatus is configured to link the source account to the credit account. Of course, in accordance with some embodiments, the source account and the credit account need not be maintained by the same financial institution (or any financial institution). For example, in some embodiments, the apparatus having the process flow 100 is configured to enable protection for exceeding a credit threshold associated with the credit account involving a checking account maintained by Financial Institution A and a credit card account maintained by Financial Institution B.

Additionally, it will be understood that, in some embodiments, the source account and the credit account are held by the same account holder (e.g., the same individual, the same business, and the like), but that in other embodiments, the source account and the credit account are held by different account holders (e.g., different individuals, different businesses, and the like). Also, it will be understood that, although much of the description herein refers to accounts held by individuals, the source account and/or the credit account may be held by one or more families, households, social networks, businesses (e.g., corporations, business units within corporations, small businesses, for-profit, non-profit, and the like), and/or other entities. For example, in some embodiments, the source account is a family checking account, and the credit account is a family credit card account, where each account is jointly held by husband and wife. As another example, in some embodiments, the source account is a small business checking account, and the credit account is a small business LOC account. Of course, it will be understood that some embodiments of the present invention may involve at least two different types of entities, such as, for example, where the source account is an individual's checking account and the credit account is a family or business credit card account.

Regarding the block 120, it will be understood that the transaction referred to in the process flow 100 can include any transaction which causes a credit threshold to be exceeded, i.e. any past, present, future, initiated, pending, completed, and the like transaction involving a credit account that results in the credit account exceeding the credit threshold. Thus, in some embodiments, the apparatus having the process flow 100 is configured to determine that a credit account has exceeded the credit threshold as a result of a past and/or completed transaction (e.g., a transaction that has already occurred, been processed, been posted, and the like). For example, in some embodiments, the apparatus is configured to determine that a credit account has exceeded the credit threshold based at least partially on receiving, analyzing, and the like information associated with the transaction history of the credit account. Examples of transaction history information include, but are not limited to, information normally found in a credit account statement, such as, for example, purchase/draw amounts, descriptions of goods/services purchased, transaction dates, monthly payments, merchant and/or counterparty names, descriptions of service payments and/or other payments, and the like

In other embodiments, the apparatus having the process flow 100 is additionally or alternatively configured to determine that a credit account will exceed the credit threshold as a result of a present, future, initiated, and/or pending transaction (e.g., a transaction that has not yet occurred but will, and the like). For example, in some embodiments, the apparatus is configured to determine that a credit account will exceed the credit threshold as a result of a transaction based at least partially on a determination that the transaction has been initiated (e.g., at a point of sale device, and the like) and/or has been authorized (e.g., by the apparatus having the process flow 100, by another apparatus, and the like), but has not yet been completed.

In addition to the above examples, it will also be understood that the apparatus having the process flow 100 can be configured to determine that a credit account has exceeded, or will exceed the credit threshold as a result of a transaction in any way. For example, in some embodiments, the apparatus is embodied as a financial transaction processing apparatus that is configured to process financial transactions involving the source account and/or credit account. In some of these embodiments, the apparatus having the process flow 100 is configured to make determinations for the credit account at the same time as, and/or nearly the same time as, the apparatus is processing transactions involving the credit account. As still another example, in some embodiments, the apparatus having the process flow 100 is embodied as an authorization apparatus configured to authorize, decline, and/or determine some other authorization decision for one or more transactions and/or other transactions involving the credit account which cause the credit threshold to be exceeded.

It will also be understood that the apparatus having the process flow 100 can be configured to make determinations in real time, in substantially real time, and/or at one or more predetermined times. For example, in some embodiments, the apparatus is configured to make determinations continuously, such that the apparatus can identify an amount by which the credit threshold has been exceeded immediately or nearly immediately after the credit threshold has been exceeded (e.g., upon the swipe of a credit card, and the like). As another example, in some embodiments, the apparatus is configured to make determinations at a specific time during the day, such as, for example, at the end of day, at mid-day, at the beginning of day, at 12:45 pm, and the like In other embodiments, the apparatus is configured to make determinations at the end of every week, at the end of the month, just after an account statement is ready, just before a payment due date, when one or more transactions post, and/or at one or more other predetermined times.

Regarding the block 130, by the term “offset,” it is meant that the total amount of funds transferred from the source account to the credit account at least equals the total amount by which the credit threshold has been exceeded, or that will be incurred, by the credit account as the result of the transaction. For example, in some embodiments, where the credit account has exceeded, or will exceed the credit threshold in the amount of $200 as a result of a transaction, the apparatus having the process flow 100 is configured to transfer exactly $200 in funds from the source account to the credit account. However, in other embodiments, where the credit account has exceeded, or will exceed the credit threshold in the amount of $200 as a result of a transaction, the apparatus having the process flow 100 is configured to transfer more than $200 in funds from the source account to the credit account. For example, in some embodiments, in addition to making the offsetting funds transfer, the apparatus is configured to apply a protection service payment to the credit account for exceeding the credit threshold and/or making the offsetting funds transfer. In some of these embodiments, the apparatus is further configured to transfer funds from the source account to the credit account in an amount sufficient to offset the amount of the service payment, thereby preventing the service payment from triggering a subsequent amount which exceeds the credit threshold and/or a subsequent service payment. As another example, in some embodiments, the apparatus having the process flow 100 is configured to transfer offsetting funds in set increments, such as, for example, in increments of $5, $25, $100, and/or the like. Thus, it will be understood that the apparatus having the process flow 100 can be configured to transfer offsetting funds in an amount equal to and/or greater than the amount by which the credit threshold has been exceeded. Of course, in embodiments where the source account is made up of a number of different accounts, the amount transferred from each source account may be less than the amount by which the credit threshold has been exceeded, but the sum of the amounts transferred will be greater than or equal to the amount of the by which the credit threshold has been exceeded.

It will also be understood that the apparatus having the process flow 100 can be configured to make offsetting funds transfers in any way. For example, in some embodiments, the apparatus is configured to electronically wire offsetting funds (e.g., cash, credit, and the like) from the source account to the credit account. In some embodiments, the apparatus is configured to transfer offsetting funds within the same financial institution and/or across one or more different financial institutions. In accordance with some embodiments, the apparatus is configured to perform one or more offsetting funds transfers via batch processing and/or via the Automated Clearing House (ACH) network. As another example, where the source account includes an investment account, in accordance with some embodiments, the apparatus is configured to liquidate one or more investments in the investment account in order to be able to transfer funds from the investment account to the credit account in an amount sufficient to offset the amount by which the credit account has been exceeded (and/or offset a related service payment). It will be understood that, in some embodiments where the source account includes a deposit account and the offsetting funds transfer is not made simultaneously with the determination, the apparatus can be configured to place a hold on funds in the source account in an amount sufficient to offset the amount by which the credit account has been exceeded. Similarly, in some embodiments where the source account includes a credit account and the offsetting funds transfer is not made simultaneously with the determination, the apparatus can be configured to reduce the amount of credit available to the source account by an amount sufficient to offset the amount by which the credit threshold has been exceeded.

It will also be understood that the apparatus having the process flow 100 can be configured to make offsetting funds transfers at any time. In some embodiments, the apparatus is configured to make an offsetting funds transfer before the credit account incurs the one or more responsibilities associated with the amount by which the credit threshold has been exceeded, thereby actually preventing the credit account from exceeding the credit threshold at all. For example, if the credit account has $50 in available credit immediately before the credit account is used to make a $100 purchase, but the credit account is not applied with the $100 purchase until after the apparatus having the process flow 100 transfers $75 in offsetting funds from the source account to the credit account, then it will be understood that, when the credit account is applied with the purchase, the credit account will have sufficient available credit to cover the purchase (i.e., $50+$75=$125→$125−$100=$25). Of course, it will be understood that, in other embodiments, the apparatus having the process flow 100 can be configured to make the offsetting funds transfer substantially simultaneous with or after the credit account exceeds the credit threshold (and/or the one or more responsibilities associated with the amount by which the credit threshold has been exceeded).

In some embodiments, the apparatus having the process flow 100 is configured to make an offsetting funds transfer at the end of the day in which the apparatus determines that the transaction which may cause the credit threshold to be exceeded has been authorized (which may or may not be the same day in which the transaction which may cause the credit threshold to be exceeded was actually authorized). As another example, in accordance with some embodiments, the apparatus having the process flow 100 is configured to make an offsetting funds transfer upon or after the transaction is initiated, while the transaction is pending, upon or after the transaction is completed, and/or upon or after the transaction posts to the credit account. As a further example, in some embodiments, the apparatus is configured to make an offsetting funds transfer at a predetermined time (e.g., apparatus-selected time, user-selected time, at the end of day in which the transaction was completed, and the like).

It will further be understood that the apparatus having the process flow 100 can be configured to transfer offsetting funds (and/or implement any one or more of the other portions of the process flow 100 represented by the blocks 110-140) upon or after one or more triggering events. As used herein, it will be understood that a “triggering event” refers to an event that automatically triggers the execution, performance, and/or implementation of a triggered action, either immediately, nearly immediately, or sometime after (e.g., within the same day or week or month, at a predetermined time, and the like) the occurrence of the triggering event. For example, in some embodiments, the apparatus having the process flow 100 is configured such that the apparatus making a determination (the triggering event) automatically triggers the apparatus to make the offsetting funds transfer (the triggered action). In some embodiments, the apparatus may be additionally configured to automatically transfer the offsetting funds immediately or nearly immediately after making the determination. However, in other embodiments, instead of immediately or nearly immediately after making the determination, the apparatus is configured to automatically transfer the offsetting funds at some predetermined time after making the determination (e.g., forty-eight hours after making the determination, at the end of day on the Friday after making the determination, and the like).

It will be understood that making an offsetting funds transfer can be referred to as “sweeping” one or more amounts that exceeds a credit threshold from a credit account. In addition, making an offsetting funds transfer can be referred to as “paying off” one or more amounts that exceed a credit threshold incurred by an account. In some cases where the offsetting funds transfer is made before the credit account exceeds the credit threshold, the offsetting funds transfer can be referred to as “prepaying” the credit account to accommodate the one or more amounts which exceed the credit threshold. For simplicity, it will be understood that, as used herein, the meaning of the term “offsetting” also includes the meanings of the terms “sweeping,” “paying off,” and/or “prepaying,” unless explicitly stated otherwise.

Also regarding the block 130, it will be understood that, where the source account and/or the credit account includes two or more accounts, the offsetting funds transfers may be made in any way. For example, in some embodiments, the apparatus having the process flow 100 is configured to transfer funds from a checking account to offset 30% of every amount that exceeds the credit threshold incurred by a credit card account and funds from a savings account to offset the other 70% of every amount that exceeds the credit threshold incurred by the credit card account. As another example, in some embodiments, the apparatus is configured to transfer funds from a checking account to offset the entire first amount which exceeds the credit threshold incurred by a credit card account and transfer funds from a savings account to offset every subsequent amount which exceeds the credit threshold incurred by the credit card account. As still another example, in some embodiments, the apparatus is configured to transfer funds only from a first checking account to offset amounts which exceed the credit threshold incurred by a first credit card account, and transfer funds only from a second checking account to offset amounts which exceed the second credit threshold incurred by a second credit card account. In some embodiments, the apparatus having the process flow 100 is configured to determine (and/or prompt a user to select) one or more rules for making an offsetting funds transfer. Specifically, in some embodiments, the apparatus is configured to transfer funds from a source account to a credit account based at least partially on a predetermined (e.g., user-selected, apparatus-selected, and the like) order, sequence, priority, and/or other selection. As an example, in some embodiments, the apparatus is configured to first use a checking account to make offsetting funds transfers, and when the checking account is nearly depleted and/or otherwise reaches a predetermined threshold, use a savings account to make offsetting funds transfers, and so on.

Regarding the block 140, it will be understood that the phrase “service payment,” as used herein, generally refers to any one or more payments associated with linking the source account to the credit account, making the determination, and/or transferring offsetting funds. It will also be understood that, in accordance with some embodiments, the apparatus can be configured to apply a protection service payment to the source account, the credit account, a holder of the source account, a holder of the credit account, and/or to some other entity. It will further be understood that the apparatus having the process flow 100 can be configured to apply a protection service payment to the credit account and/or to the source account at any time and/or at any frequency (e.g., per day, at the end of day, per transaction which causes the credit threshold to be exceeded, upon authorization of a transaction which causes the credit threshold to be exceeded, at the end of every statement period in which the credit account incurs one or more amounts which exceed the credit card threshold, in advance of a period of time in which the credit account will have protection for exceeding a credit threshold associated with the credit account, and the like).

It will also be understood that the service payment may take any form. For example, in some embodiments, the apparatus having the process flow 100 is configured to apply a protection service payment having a set amount (e.g., $39 per transaction which causes the credit threshold to be exceeded, $250 for a one year subscription to a protection service, and the like) to the credit account and/or the source account. As another example, in some embodiments, the apparatus is configured to apply a protection service payment having a proportional amount (e.g., a percentage of a transaction which causes a credit threshold to be exceeded, a percentage of the balance of the source account, and the like) to the credit account and/or to the source account. In some embodiments, the service payment is embodied as something other than a monetary payment. For example, in some embodiments, the service payment includes an increase in an interest rate, a reduction in cash back awards, a reduced maximum credit threshold, and/or one or more other changes to one or more features associated with the credit account and/or source account. However, it will be understood that the phrase “service payment,” as used herein, shall not mean no service payment. In other words, when it is said that an apparatus applies a service payment, it will be understood that the apparatus takes some meaningful action towards a financial account, financial account holder, and/or some other entity.

It will be understood that one or more of the portions of the process flow 100 represented by the blocks 110-140 may serve as a triggering event for one or more of the other portions represented by the blocks 110-140. For example, as already mentioned, the apparatus having the process flow 100 can be configured to automatically transfer the offsetting funds immediately, nearly immediately, or sometime after determining that the credit account has exceeded, or will exceed the credit threshold as a result of the transaction. As another example, in some embodiments, the apparatus is configured to automatically apply a protection service payment upon or after transferring the offsetting funds. In some embodiments, a predetermined time and/or the passage of a predetermined period of time may serve to trigger one or more of the portions represented by the blocks 110-140. For example, in some embodiments, the apparatus having the process flow 100 is configured to automatically transfer offsetting funds from the source account to the credit account three days after determining that the credit account has exceeded the credit threshold.

Further, it will be understood that the number, order, and/or content of the portions represented by the blocks 110-140 are exemplary and may vary. For example, in some embodiments, the apparatus is configured to omit the service payment portion of the process flow 100 represented by the block 140. As another example, in some embodiments, the apparatus having the process flow 100 is configured to apply the protection service payment after determining that the credit account has exceeded, or will exceed the credit threshold, but before transferring the offsetting funds.

Also, in some embodiments, the apparatus having the process flow 100 is configured to determine whether the source account has sufficient funds (e.g., sufficient cash, sufficient credit, and the like) to offset the amount which exceeds the credit threshold before making the offsetting funds transfer from the source account to the credit account. It will be understood that these sufficiency determinations can be made in any way, such as, for example, by analyzing the transaction history of the source account. It will also be understood that, in accordance with some embodiments, if the source account does not have sufficient funds to make the offsetting funds transfer, then the apparatus may be configured to decline the transaction, and/or to stop, queue, and/or otherwise prevent the offsetting funds transfer from being made in order to prevent the source account from exceeding the available fund or credit threshold.

Alternatively, in embodiments where one or more additional source accounts having sufficient funds are linked to the credit account, the apparatus can be configured to transfer offsetting funds from those one or more additional source accounts instead from the source account with unavailable funds. In some of these embodiments, the apparatus may be configured to follow a particular priority, order, and/or sequence when determining the source account(s) from which to transfer offsetting funds. For example, in some embodiments, the apparatus is configured to offset an amount which exceeds the credit threshold using the source account with the highest account balance and/or available credit. As another example, in some embodiments, the apparatus is configured to use a preferred account to offset the amount which exceeds the credit threshold unless and/or until that preferred account does not have sufficient funds to make the offsetting funds transfer.

As still another example, in some alternate embodiments, the apparatus having the process flow 100 is configured to aggregate multiple individual amounts which exceed the credit threshold before making offsetting funds transfers. For example, suppose a credit card account holder incurs a $10 amount which exceeds the credit threshold on Monday morning as a result of a first transaction, a $100 amount which exceeds the credit threshold on Monday afternoon as a result of a second transaction, and a $30 amount which exceeds the credit threshold on Monday evening as a result of a third transaction. In such a case, the apparatus may be configured to aggregate those individual amounts which exceed the credit threshold and then transfer funds from the credit card account holder's checking account to the holder's credit card account in an amount sufficient to offset those responsibilities. In other words, the apparatus can be configured to make a one-time offsetting funds transfer of $140 at some later time on Monday instead of making three smaller offsetting funds transfers during the day on Monday (as other embodiments of the apparatus are configured to do).

In some embodiments, the triggering event for implementing one or more of the portions represented by the blocks 110-140 includes a predetermined time and/or the passage of a predetermined period of time. Examples of temporal triggering events include, but are not limited to, the end of day on a particular day, the beginning of day on the first and fifteenth of every month, 12:00 pm on the payment due date, 3:00 pm every Tuesday, 11:59 pm on the Monday before the end of the month, after every ten day period, two weeks after the previous payment, two days before a student loan payment is scheduled to be paid using funds from the source account, and the like It will be understood that, in some embodiments, triggering events are scheduled as one-time only events (e.g., at 2:57 pm on Dec. 27, 2009, and the like), but that in other embodiments, triggering events are recurring such that they occur periodically (e.g., after every deposit, every other Monday, at the first of every month, and the like). It will also be understood that the apparatus having the process flow 100 can be configured to determine any number of triggering events, as well as make any number of offsetting funds transfers, such that, in some embodiments, the apparatus is configured to make an offsetting funds transfer as often as every day, upon or after every transaction which causes the credit threshold to be exceeded, and/or even more frequently.

It will be understood that, in some embodiments, the apparatus having the process flow 100 is also configured to implement, communicate with, and/or be otherwise associated with online and/or mobile banking services. For example, in some embodiments, the apparatus having the process flow 100 is also configured to deliver online and/or mobile banking services to one or more online banking customers via one or more online and/or mobile banking accounts. As another example, in some embodiments, one or more portions of an online and/or mobile banking account (e.g., an online banking tool, and the like) are configured to configure and/or trigger the apparatus having the process flow 100 to perform the portions of the process flow 100. In some embodiments, one or more portions of an online and/or mobile banking account are additionally or alternatively configured to configure (and/or facilitate an online banking customer to configure) the apparatus having the process flow 100 and/or the portions of the process flow 100. For example, in some embodiments, an online banking customer may access an online banking tool via an online banking account in order to select which accounts to link, schedule when determinations and/or offsetting funds transfers are made, and so on. In some embodiments, the online and/or mobile banking account may additionally or alternatively be configured to receive one or more notifications associated with one or more of the portions of the process flow 100 (e.g., an e-mail message created/sent by the apparatus that confirms that two accounts have been linked, a digital receipt created/sent by the apparatus that has information associated with the offsetting funds transfer, and the like).

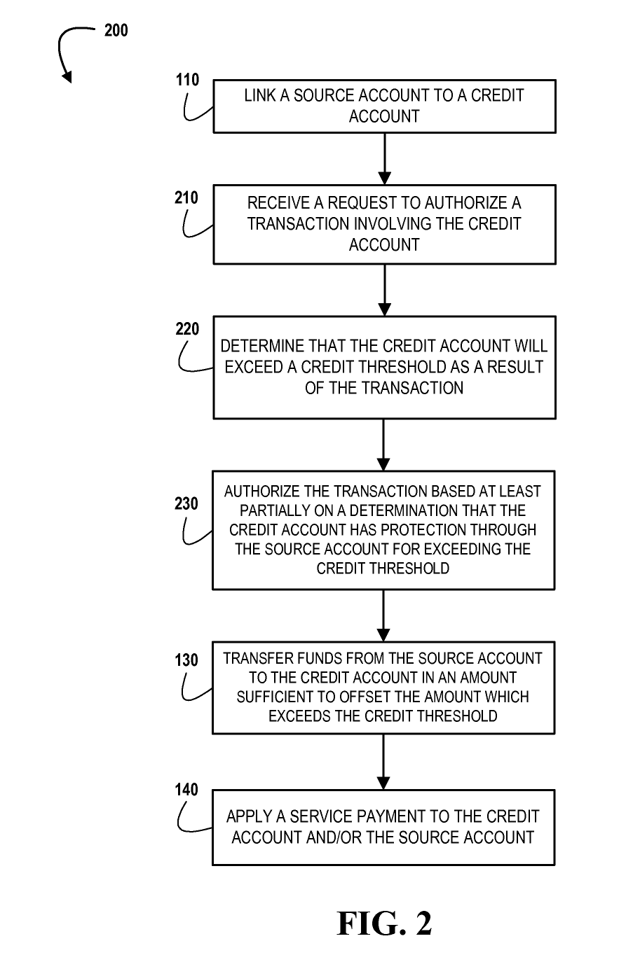

Referring now to FIG. 2, a general process flow 200 is provided as an alternative embodiment to the general process flow 100 illustrated in FIG. 1. As shown in FIG. 2, an apparatus having the process flow 200 is configured to perform generally the same process flow as the process flow 100, except that the apparatus having the process flow 200 is additionally configured to: (a) receive a request to authorize the transaction involving the credit account, as represented by the block 210; (b) determine that the credit account will exceed the credit threshold as a result of the transaction, as represented by the block 220; and (c) authorize the transaction based at least partially on a determination that the credit account has protection through the source account for exceeding a credit threshold associated with the credit account, as represented by the block 230.

It will be understood that, in accordance with some embodiments, the apparatus having the process flow 200 is configured to perform one or more portions of the process flow 200 after the transaction has been initiated but before the transaction has been completed (i.e., while the transaction is still pending). It will also be understood that, in accordance with some embodiments, the apparatus is additionally or alternatively configured to perform one or more portions of the process flow 200 in real time and/or near real time (collectively referred to herein as “substantially real time” for simplicity).

For example, in some embodiments, the apparatus having the process flow 200 is maintained by a credit card-issuing bank and is configured to communicate, via a network, with a credit card association and the like and/or an acquiring bank. For example, when a purchase transaction is initiated via an e-commerce web site, by swiping a credit card at a merchant's point of sale (POS) device, and/or the like, the information associated with the purchase transaction is communicated to the merchant's acquiring bank (i.e., the bank that accepts payments for goods and/or services on behalf of the merchant). The acquiring bank then communicates the transaction information to the appropriate credit card association, which routes the transaction information, along with a request to authorize the purchase transaction, to the correct credit card-issuing bank where it is received at the apparatus having the process flow 200 (e.g., because, in some embodiments, the card-issuing bank maintains the apparatus having the process flow 200, and the like). The apparatus then determines an authorization decision (e.g., authorize the transaction, decline the transaction, and the like) and communicates information associated with that authorization decision back to the credit card association and/or the acquiring bank, where it is forwarded to the merchant at the POS device, e-commerce web site, and the like, so that the purchase transaction can be completed.

It will be understood that, in accordance with some embodiments, the apparatus having the process flow 200 is configured to execute the entire process flow 200 in substantially real time after the transaction has been initiated and before the transaction has been completed. However, in other embodiments, it will be understood that the apparatus having the process flow 200 is configured to perform the portions represented by the blocks 210-230 after the transaction has been initiated but before the transaction has been completed, and then perform the portions represented by the blocks 130 and 140 after the transaction has been completed.

Regarding the block 230, it will be understood that the apparatus having the process flow 200 can be configured to authorize the transaction based at least partially on one or more determinations other than the determination that the credit account has protection through the source account for exceeding a credit threshold associated with the credit account. For example, in some embodiments, the apparatus is additionally configured to authorize the transaction based at least partially on a determination that the source account has sufficient funds to offset the amount which exceeds the credit threshold and/or offset a service payment associated with the amount which exceeds the credit threshold. As another example, in some embodiments, the apparatus is configured to authorize the transaction based at least partially on a determination that the credit account and/or a holder of the credit account has been properly authenticated (e.g., via a username/password, PIN number, expiration date, card code verification (CCV) number, an authentication microchip located in a credit card, and the like).

As still another example, in some embodiments of the present invention, the apparatus having the process flow 200 is additionally or alternatively configured to determine an authorization decision for the transaction which causes the credit threshold to be exceeded based at least partially on one or more user-selected and/or apparatus-selected parameters (collectively referred to herein as “predetermined parameters” for simplicity). For example, in some embodiments, the apparatus is configured to determine an authorization decision for the transaction which causes the credit threshold to be exceeded based at least partially on a determination that the transaction was initiated inside, outside, and/or otherwise relative to one or more predetermined (e.g., user-selected, apparatus-selected, and the like) geographic areas and/or locations (collectively referred to herein as “predetermined geographic areas” for simplicity) in order to, for example, reduce or prevent fraud. As an example, in some embodiments, the apparatus is configured to decline any transaction which cause the credit threshold to be exceeded that occurs outside of the United States. As still another example, in some embodiments, the apparatus is configured to decline any transaction which cause the credit threshold to be exceeded that occurs in a grocery store. As still another example, in some embodiments, the apparatus is configured to authorize every transaction that occurs within ten miles from the holder's residence.

As another example of a predetermined parameter, in some embodiments, the apparatus having the process flow 200 is additionally or alternatively configured to determine an authorization decision for the transaction which cause the credit threshold to be exceeded based at least partially on a determination that the amount by which the credit threshold is exceeded is less than, equal to, greater than, included in, excluded from, and/or otherwise relative to one or more predetermined (e.g., user-selected, apparatus-selected, and the like) amounts which exceed the credit threshold, ranges, and/or sets. In some embodiments, for example, the apparatus is configured to decline any transaction that will result in the credit account incurring an amount which exceeds the credit threshold greater than a predetermined amount (e.g., in some embodiments, the “maximum amount which exceeds the credit threshold” is $100, and the like). Other exemplary predetermined parameters include, but are not limited to, the number and/or identity of the parties involved in the transaction, the channel through which the transaction is initiated and/or completed (e.g., POS device, e-commerce web site, and the like), the type of the transaction (e.g., purchase, service payment, payment, draw, and the like), the time of the transaction, and/or the like. It will be understood that, in accordance with some embodiments of the present invention, the apparatus having the process flow 200 (and/or any of the other embodiments of the apparatus described and/or contemplated herein) is configured to prompt and/or enable a credit account holder, via, for example, the holder's online and/or mobile banking account, to select and/or set one or more predetermined parameters for providing protection for exceeding a credit threshold associated with the credit account.
For example, in some embodiments, the apparatus having the process flow 200 is configured to prompt the credit account holder to select and/or set the maximum amount which exceeds the credit threshold, the predetermined geographic area, and/or the like. As such, it will be understood that, in some embodiments, the “user” is the “holder” and vice versa.

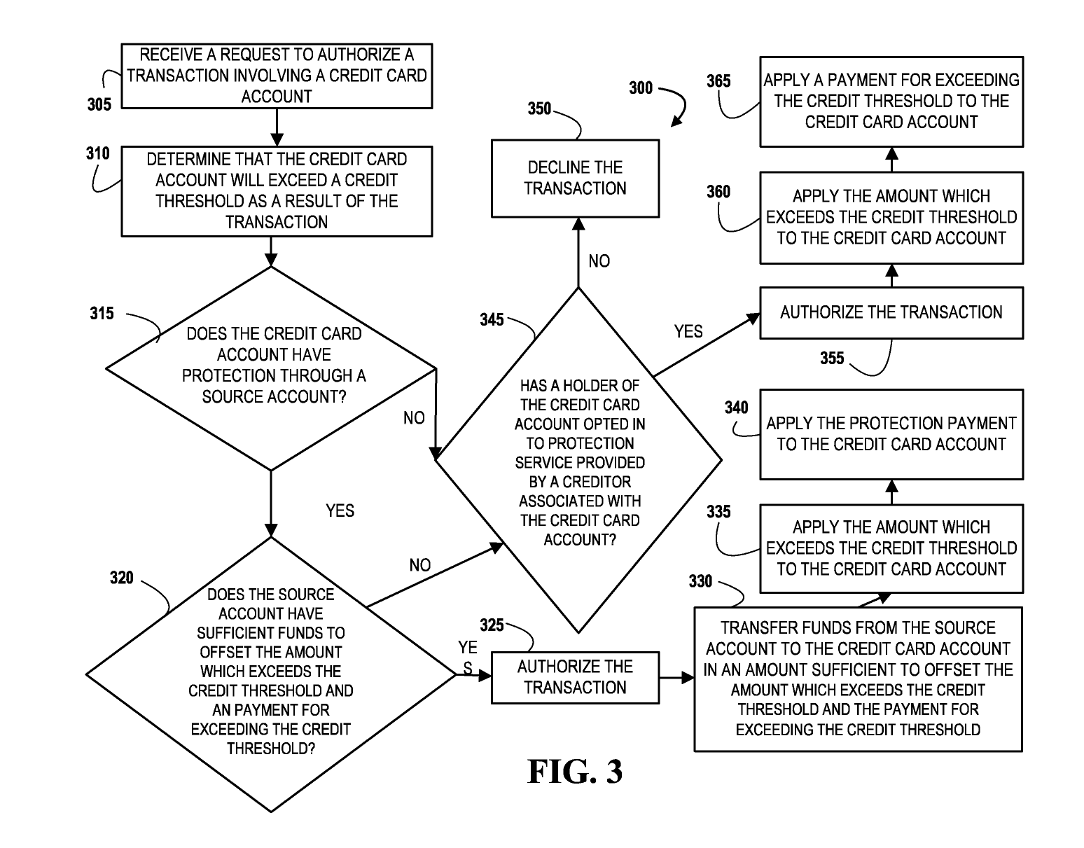

Referring now to FIG. 3, a more-detailed process flow 300 of an apparatus for providing protection for exceeding a credit threshold associated with a credit card account is provided, in accordance with an embodiment of the present invention. As represented by the block 305, the apparatus having the process flow 300 is configured to receive a request to authorize a transaction involving the credit card account. As represented by the block 310, the apparatus is configured to determine that the credit card account will exceed the credit threshold as a result of the transaction. As represented by the block 315, the apparatus is also configured to determine whether the credit card account has protection through a source account for exceeding a credit threshold associated with the credit card account. If yes, then, as represented by the block 320, the apparatus is configured to determine whether the source account has sufficient funds to offset the amount which exceeds the credit threshold and to offset an protection payment for exceeding the credit threshold (e.g., a service payment associated with protection for exceeding the credit threshold, such as, for example, a service payment associated with making an offsetting funds transfer, and the like). If yes, then the apparatus having the process flow 300 is configured to authorize the transaction, as represented by the block 325, and transfer funds from the source account to the credit card account in an amount sufficient to offset the amount which exceeds the credit threshold and offset the protection payment for exceeding the credit threshold, as represented by the block 330. After transferring the offsetting funds, the apparatus is configured to apply the amount by which the credit account is exceeded to the credit card account, as represented by the block 335, and apply the protection payment for exceeding the credit threshold to the credit card account, as represented by the block 340. Of course, it will be understood that any of these portions of the process flow 300 can be executed in accordance with any one or more of the embodiments described and/or contemplated herein.

However, if the apparatus having the process flow 300 determines that the source account does not have sufficient funds to offset the protection payment for exceeding the credit threshold, or if the apparatus determines that the credit card account does not have protection through a source account for exceeding the credit threshold, then the apparatus is configured to determine, as represented by the block 345, whether a holder of the credit card account has “opted in” to a “protection service” provided by a creditor associated with the credit card account (e.g., a credit card-issuing bank that maintains the credit card account, and the like). In other words, the apparatus having the process flow 300 is configured to determine, at the block 345, whether the credit card account holder has expressly elected (“opted in”) to permit the creditor associated with the credit card account to: (a) authorize (and/or otherwise complete) one or more transactions involving the credit card account that result in the credit card account incurring one or more amounts which exceed the credit threshold, and (b) apply one or more payments for exceeding the credit threshold associated with the one or more transactions to the credit card account which cause the credit threshold to be exceeded, to the credit card account holder, and/or to some other entity (collectively “the protection service”). It will be understood that the phrases “opt in” and the “protection service” referred to herein are each provided in accordance with the Credit Card Accountability Responsibility and Disclosure Act of 2009, which is codified in the United States as Public Law No. 111-24 (sometimes referred to herein, for simplicity, as the “Credit CARD Act of 2009” or the “CARD Act”), and/or in accordance with some other similar law, rule, and/or regulation. The CARD Act states, in relevant part, that:
(k) Opt-in Required for [exceeding the credit threshold] Transactions if [exceeding the available funds or credit threshold] Service Payments Are Imposed.
   (1) In general. In the case of any credit card account under an open end consumer credit plan under which a [amount which exceeds the credit threshold] service payment may be imposed by the creditor for any extension of credit in excess of the amount of credit authorized to be extended under such account, no such service payment shall be applied, unless the [credit card account holder] has expressly elected to permit the creditor, with respect to such account, to complete transactions involving the extension of credit under such account in excess of the amount of credit authorized.
      Thus, it will be understood that the CARD Act requires the credit card account holder to opt in to the protection service described above before the creditor is legally permitted to provide such a protection service. (It will also be understood that, in accordance with some embodiments of the present invention, the apparatus having the process flow 300 (and/or any of the other embodiments described and/or contemplated herein) is configured to prompt and/or enable the credit card account holder to opt in to the protection service via, for example, the holder's online and/or mobile banking account.) Accordingly, if the holder has not opted in to the protection service in accordance with the CARD Act and/or other similar law, rule, and/or regulation, then the apparatus having the process flow 300 is configured to decline the transaction, as represented by the block 350.

On the other hand, if the credit card account holder has opted in to the protection service in accordance with the CARD Act and/or other similar law, rule, and/or regulation, then the apparatus having the process flow 300 is configured to authorize the transaction, as represented by the block 355. After authorizing the transaction, the apparatus having the process flow 300 is configured to apply the amount which exceeds the credit threshold to the credit card account, as represented by the block 360, and apply a payment for exceeding the available funds or credit threshold to the credit card account, as represented by the block 365. As such, in accordance with some embodiments, the service payment for exceeding the credit threshold is “imposed by the creditor for [an] extension of credit in excess of the amount of credit authorized to be extended,” in accordance with the CARD Act.

It will be understood that the phrases “payment for exceeding the available funds or credit threshold” and “protection payment for exceeding the credit threshold” both refer to service payments, which may be, in accordance with some embodiments, similar and/or identical. As such, this difference in phrasing is not necessarily meant to imply a different type and/or amount of service payment. Instead, this phrasing is used herein for simplicity, to help avoid reader confusion, and generally to indicate that the protection payment for exceeding the credit threshold corresponds to the protection service and that the payment for exceeding the available funds or credit threshold corresponds to the protection service.

Of course, in accordance with some embodiments, the amount of the payment for exceeding the available funds or credit threshold referred to in the block 365 is greater than the amount of the payment for exceeding the credit threshold referred to in the blocks 320, 330, and 340. In some cases, this may be to, for example, incentivize the credit card account holder to set up protection through the source account for exceeding the credit threshold instead of, and/or in addition to, opting in to the protection service. Also, it will be understood that, in some embodiments, the protection referred to the process flow 300 is a service provided by the same creditor that provides the protection service referred to in the process flow 300.

It will be understood that the payment for exceeding the credit threshold referred to in blocks 320, 330, 340, and elsewhere herein is not “imposed by the creditor for [an] extension of credit in excess of the amount of credit authorized to be extended,” but rather, is applied to the credit card account (and/or to the source account, other entity, and the like) for using the protection service (e.g., making an offsetting funds transfer, and the like). This is true even where the credit card account is actually extended credit in excess of the amount of credit authorized to be extended, such as, for example, where the offsetting funds transfer is made after the credit card account is applied with the amount which exceeds the credit threshold and the protection payment for exceeding the credit threshold. As such, the protection payment for exceeding the credit threshold referred to herein does not fall within the purview of the CARD Act.

In some embodiments, the protection payment for exceeding the credit threshold does not fall within the purview of the CARD Act for an additional reason. Specifically, in embodiments where the offsetting funds transfer is made before the credit card account is applied with the protection payment for exceeding the credit threshold and the amount which exceeds the credit threshold (e.g., the process flow 300), the credit card account does not exceed the credit threshold within the meaning of the CARD Act because the creditor never actually extends the credit card account “credit in excess of the amount of credit authorized to be extended” (e.g., credit beyond the maximum credit threshold associated with the credit card account, and the like). Indeed, as represented by the blocks 330-340, the apparatus having the process flow 300 is configured to “prepay” the credit card account with funds from the source account, such that there is sufficient credit available in the credit card account to cover the amount which exceeds the credit threshold and the protection payment for exceeding the credit threshold when those items are applied to the credit card account. In contrast, as mentioned previously, the payment for exceeding the available funds or credit threshold referred to in the block 365 falls squarely within the purview of the CARD Act because it is “imposed by the creditor for [an] extension of credit in excess of the amount of credit authorized to be extended.”

It will be understood that, in accordance with some embodiments, the apparatus having the process flow 300 is configured to authorize the transaction which causes the credit threshold to be exceeded involving the credit card account where: (1) the credit card account has protection through a source account and the source account has sufficient funds to offset the amount which exceeds the credit threshold and offset a payment for exceeding the credit threshold; (2) the credit card account has protection through a source account, the source account does not have enough funds to offset the amount which exceeds the credit threshold and/or an protection payment for exceeding the credit threshold, but the credit card account holder has opted in to an protection service provided by a creditor associated with the credit card account, where the protection service provides protection for exceeding a credit threshold; or (3) the credit card account does not have protection through a source account, but the credit card account holder has opted in to an protection service provided by a creditor associated with the credit card account.

On the other hand, it will be understood that, in accordance with some embodiments, the apparatus having the process flow 300 is configured to decline the transaction which causes the credit threshold to be exceeded involving the credit card account where: (1) the credit card account has protection through a source account, the source account does not have enough funds to offset the amount which exceeds the credit threshold and/or offset an protection payment for exceeding the credit threshold, and the credit card account holder has not opted in to a protection service provided by a creditor associated with the credit card account; or (2) the credit card account does not have protection through a source account, and the credit card account holder has not opted in to an protection service provided by a creditor associated with the credit card account. It will be understood that, in some embodiments, the apparatus having the process flow 300 can be configured to decline the transaction involving the credit card account for one or more additional or alternative reasons, including, for example, where the amount which exceeds the credit threshold is greater than a predetermined amount (e.g., the maximum amount which exceeds the credit threshold, and the like), where the transaction occurs outside of a predetermined geographic area (e.g., decline any credit card transaction that occurs in a casino, and the like), and/or the like.

It will be understood that, in other embodiments of the present invention, the apparatus having the process flow 300 can be additionally or alternatively configured to generate and/or transmit a notification to a device accessible to the holder, where the notification: (a) notifies the holder that the credit card account will exceed the credit threshold as a result of the transaction, and (b) prompts the holder to authorize the transaction or decline the transaction. It will be understood that the notification may take any form (e.g., email, text message, instant message, phone call, message received via a mobile app located on a mobile phone, message received via an application located on a POS device, and the like), and that the device accessible to the holder may take any form (e.g., mobile phone, pager, personal digital assistant (PDA), personal computer, POS device, and the like). In some embodiments, the notification is generated and/or transmitted in substantially real time, so that, for example, the holder can respond to the prompt while the transaction is still pending. Further, it will be understood that the device to which the notification is communicated, and/or the notification itself, can include functionality (e.g., selectable link, fillable field, email address, phone number, and the like) that enables the holder to respond to the prompt in the notification. Of course, it will be understood that the apparatus can be configured to receive the response to the notification from the holder in any form and via any medium (e.g., email, text message, instant message, phone call, and the like). It will also be understood that, in accordance with some embodiments, the apparatus having the process flow 300 is configured to generate the notification, transmit the notification to the holder, receive the response to the notification from the holder, and authorize or decline the transaction based at least partially on the holder's response, all of which occur sometime after the apparatus determines that the credit card account will exceed the credit threshold as a result of the transaction and sometime before the apparatus authorizes or declines the transaction.

In addition to, or instead of, prompting the holder to authorize or decline the transaction, in some embodiments, the notification prompts the user to select one or more source accounts from which to provide funds to offset the amount which exceeds the credit threshold. For example, in some embodiments, after determining that the credit card account will exceed the credit threshold as a result of the transaction and after determining that the credit card account has protection through both a checking account and a savings account for exceeding the credit threshold, the apparatus having the process flow 300 is configured to prompt the holder to choose how to offset the amount which exceeds the credit threshold using available funds from the checking account and/or the savings account.

Additionally or alternatively, in some embodiments, the apparatus having the process flow 300 is configured to generate and/or transmit a notification to the holder that prompts the holder to opt-in to an protection service provided by a creditor associated with the credit card account. In such embodiments, if the credit card account does not have protection through the source account for exceeding the credit threshold, the holder can respond to the notification to opt-in to the protection service in order to ensure that the transaction is authorized by the apparatus. As another example, in some embodiments, the apparatus having the process flow 300 is additionally or alternatively configured to generate and/or transmit a notification to the holder that prompts the holder to authorize or decline, for a particular transaction, the use of the protection service and/or the use of the protection service provided by the creditor associated with the credit card account.

In some embodiments of the present invention, the apparatus having the process flow 300 is additionally or alternatively configured to determine whether the credit card account holder and/or credit card account satisfies one or more credit requirements (e.g., related to the holder's credit score, record for exceeding the credit threshold, and the like) after determining that the holder has opted in to the protection service and before authorizing the transaction. In such embodiments, if the one or more credit requirements are satisfied, then the apparatus is configured to authorize the transaction; but if they are not, the apparatus is configured to decline the transaction.

Also, in some alternative embodiments, the apparatus is configured to determine that the credit card account holder has opted in to the protection service provided by the creditor based at least partially on a determination that the credit card account has protection through the source account for exceeding the credit threshold (which may, in some embodiments, also be provided by the creditor). In other words, in accordance with some embodiments, the credit card account holder can automatically opt in to the service by enrolling in the protection service (i.e., the holder's enrollment in the protection service serves as the holder's opt in to the service). In such embodiments, the apparatus can be configured to transfer the offsetting funds from the source account to the credit card account before, after, or substantially simultaneous with applying the amount by which the available funds or credit threshold is exceeded and/or the protection payment for exceeding the credit threshold to the credit card account. Of course, it will further be understood that some alternative embodiments of the process flow 300 involve, where possible, one or more other types of credit accounts instead of, or in addition to, a credit card account.

It will also be understood that, in some embodiments, the apparatus having the process flow 300 is configured to: (a) authorize a transaction that results in an exceeding the credit threshold; (b) transfer funds from the source account to the credit card account in order to offset part of the amount which exceeds the credit threshold; and (c) apply the rest of the amount which exceeds the credit threshold to the credit card account. As such, it will be understood that, for a single transaction, a holder may utilize both the protection service involving the source account and the protection service requiring the opt-in. This may be useful where the source account does not have sufficient funds to offset the entire amount which exceeds the credit threshold but does have some funds to offset part of the amount which exceeds the credit threshold. It will also be understood that, in such embodiments, the credit card account (and/or the source account, the holder, and the like) may incur both a payment for exceeding the available funds or credit threshold and a protection payment for exceeding the credit threshold for that single transaction.

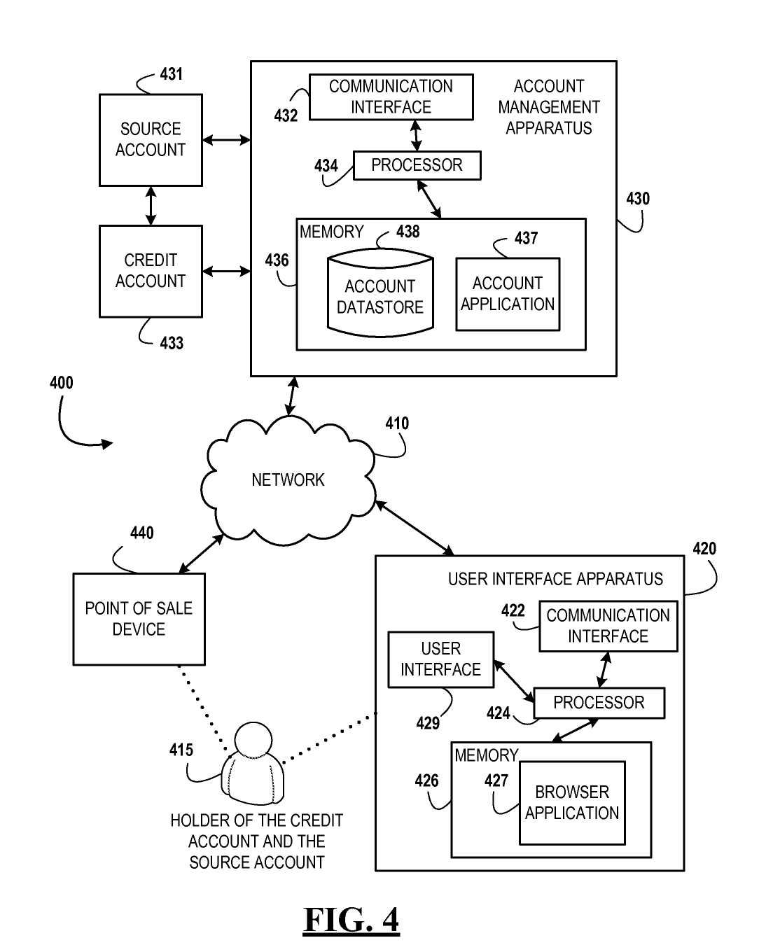

Referring now to FIG. 4, a system 400 for providing protection for exceeding the credit threshold is provided, in accordance with an embodiment of the present invention. As illustrated, the system 400 includes a network 410, a user interface apparatus 420, an account management apparatus 430, and a point of sale device 440. FIG. 4 also illustrates a source account 431 (e.g., a checking account, savings account, investment account, credit card account, and the like) and a credit account 433 (e.g., a credit card account, LOC account, HELOC account, and the like), both of which are operatively connected (e.g., linked) to the account management apparatus 430, as well as to each other. Also shown in FIG. 4 is the holder 415 of the source account 431 and the credit account 433. It will be understood that the holder 415 has access to the user interface apparatus 420 and the point of sale device 440. In this embodiment, the user interface apparatus 420 is maintained by the holder 415, the point of sale device 440 is maintained by a merchant (not shown), and the account management apparatus 430, along with the credit account 431 and the deposit account 433, are maintained by a single financial institution (not shown) for the benefit of the holder 415. It will also be understood that the holder 415 may use the source account 431 and/or the credit account 433 to make one or more purchases from the merchant by using the point of sale device 440.

As shown in FIG. 4, the user interface apparatus 420, the account management apparatus 430, and the point of sale device 440 are each operatively and selectively connected to the network 410, which may include one or more separate networks. In addition, the network 410 may include a local area network (LAN), a wide area network (WAN), and/or a global area network (GAN), such as the Internet. It will also be understood that the network 410 may be secure and/or unsecure and may also include wireless and/or wireline technology.

The user interface apparatus 420 may include any computerized apparatus that can be configured to perform any one or more of the functions of the user interface apparatus 420 described and/or contemplated herein. In some embodiments, for example, the user interface apparatus 420 may include a personal computer system, a mobile phone, a personal digital assistant, a public kiosk, a network device, and/or the like. As illustrated in FIG. 4, in accordance with some embodiments of the present invention, the user interface apparatus 420 includes a communication interface 422, a processor 424, a memory 426 having a browser application 427 stored therein, and a user interface 429. In such embodiments, the communication interface 422 is operatively and selectively connected to the processor 424, which is operatively and selectively connected to the user interface 429 and the memory 426.

Each communication interface described herein, including the communication interface 422, generally includes hardware, and, in some instances, software, that enables a portion of the system 400, such as the user interface apparatus 420, to transport, send, receive, and/or otherwise communicate information to and/or from the communication interface of one or more other portions of the system 400. For example, the communication interface 422 of the user interface apparatus 420 may include a modem, server, electrical connection, and/or other electronic device that operatively connects the user interface apparatus 420 to another electronic device, such as the electronic devices that make up the account management apparatus 430.

Each processor described herein, including the processor 424, generally includes circuitry for implementing the audio, visual, and/or logic functions of that portion of the system 400. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the browser application 427 of the memory 426 of the user interface apparatus 420.

Each memory device described herein, including the memory 426 for storing the browser application 427 and other data, may include any computer-readable medium. For example, memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 4, the memory 426 includes the browser application 427. In some embodiments, the browser application 427 includes a web browser and/or some other application for communicating with, navigating, controlling, configuring, and/or using the account management apparatus 430 and/or other portions of the system 400. For example, in some embodiments, the holder 415 uses the browser application 427 to trigger and/or configure one or more aspects of the account management apparatus 430 that relate to making determinations and/or offsetting funds transfers. For example, in some embodiments, the holder 415 uses the browser application 427 to select one or more accounts (e.g., the source account 431 and the credit account 433, and the like) for linking. As another example, in some embodiments, the holder 415 uses the browser application 417 to view a notification regarding an amount which exceeds the credit threshold received from the account management apparatus 430, and/or to transmit a response to that notification to the account management apparatus 430. It will be understood that, in some embodiments, the holder 415 uses the browser application 427 to access an online and/or mobile banking account (not shown) for configuring one or more aspects of the account management apparatus 430. In some embodiments, the browser application 427 includes computer-executable program code portions for instructing the processor 424 to perform one or more of the functions of the browser application 427 described and/or contemplated herein. In some embodiments, the browser application 427 may include and/or use one or more network and/or system communication protocols.

Also shown in FIG. 4 is the user interface 429. In some embodiments, the user interface 429 includes one or more user output devices, such as a display and/or speaker, for presenting information to the holder 415 and/or some other user. In some embodiments, the user interface 429 includes one or more user input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the holder 415 and/or some other user. In some embodiments, the user interface 429 includes the input and display devices of a personal computer, such as a keyboard and monitor, that are operable to receive and display information associated with offsetting a responsibility and/or accumulating rewards.

FIG. 4 also illustrates an account management apparatus 430, in accordance with an embodiment of the present invention. The account management apparatus 430 may include any computerized apparatus that can be configured to perform any one or more of the functions of the account management apparatus 430 described and/or contemplated herein. In accordance with some embodiments, for example, the account management apparatus 430 may include an engine, a platform, a server, a database system, a front end system, a back end system, a personal computer system, and/or the like. In some embodiments, such as the one illustrated in FIG. 4, the account management apparatus 430 includes a communication interface 432, a processor 434, and a memory 436, which includes an account application 437 and an account datastore 438 stored therein. As shown, the communication interface 432 is operatively and selectively connected to the processor 434, which is operatively and selectively connected to the memory 436.

It will be understood that the account application 437 can be configured to implement any one or more portions of any one or more of the process flows described and/or contemplated herein. For example, in some embodiments, the account application 437 is configured to link the source account 431 to the credit account 433. As another example, in some embodiments, the account application 437 is configured to determine that the credit account 431 has exceeded, or will exceed a credit threshold as a result of a transaction. As still another example, in some embodiments, the account application 437 is configured to transfer funds from the source account 431 to the credit account 433 in an amount sufficient to offset an amount which exceeds the credit threshold that has been incurred, or that will be incurred, by the credit account 433 as a result of a transaction. As a further example, in some embodiments, the account application 437 is configured to apply a service payment to the source account 431 and/or the credit account 433. As other examples, in some embodiments, the account application 437 is configured to: (a) receive a request to authorize a transaction involving the credit account 433, (b) determine that the credit account 433 will exceed a credit threshold as a result of the transaction, and/or (c) authorize the transaction based at least partially on a determination that the credit account 433 has protection through the source account 431 for exceeding the credit threshold. As still another example, in some embodiments, the account application 437 is additionally or alternatively configured to: (a) generate a notification regarding the amount which exceeds the credit threshold (e.g., a notification that prompts the holder to authorize or decline the transaction and/or to choose a source account to use in offsetting the amount which exceeds the credit threshold, and the like); (b) transmit the notification to a device accessible to the holder 415 (e.g., the user interface apparatus 420, and the like) while the transaction is still pending; (c) receive a response to the notification (e.g., from the holder via the user interface apparatus 420, and the like); and (d) authorize the transaction based at least partially on the response.

It will also be understood that, in some embodiments, the account application 437 is additionally configured to provide other kinds of financial services. For example, in some embodiments, the account application 437 may be operable to process financial transactions involving the source account 431 and/or the credit account 433. In some cases, this function is performed alongside one or more of the portions described and/or contemplated herein that relate to receiving authorization requests, making determinations, determining authorization decisions, transferring offsetting funds, and/or applying service payments. For example, where the holder 415 initiates a purchase transaction using the credit account 433 at the point of sale device 440, the account application 437 may be configured to authorize the purchase transaction, as well as simultaneously (or sometime thereafter) determine that the credit account 433 has exceeded, or will exceed the credit threshold as a result of the purchase transaction, and/or transfer offsetting funds from the source account 431 to the credit account 433. As another example, in some embodiments, the account application 437 is configured to provide online and/or mobile banking services to the holder 415 at the user interface apparatus 420, such as, for example, any of the online and/or mobile banking services described and/or contemplated herein.

It will also be understood that, in some embodiments, the account application 437 is configured to communicate with the account datastore 438, the user interface apparatus 420, the point of sale device 440, and/or any one or more other portions of the system 400. For example, in some embodiments, the account application 437 is configured to receive transaction information from and/or send authorization information to the point of sale device 440. As another example, in some embodiments, the account application 437 is configured to create and/or send one or more notifications to the holder 415 at the user interface apparatus 420 that explain, for example, that the credit account 433 has incurred an amount which exceeds the credit threshold, and/or that offsetting funds have been transferred from the source account 431 to the credit account 433. It will be further understood that, in some embodiments, the account application 437 includes computer-executable program code portions for instructing the processor 434 to perform any one or more of the functions of the account application 437 described and/or contemplated herein. In some embodiments, the account application 437 may include and/or use one or more network and/or system communication protocols.

In addition to the account application 437, the memory 436 also includes the account datastore 438. In some embodiments, the account datastore 438 includes information associated with one or more financial accounts (e.g., the source account 431, the credit account 433, one or more non-financial institution accounts (not shown), and the like), including, for example, account names, persons and/or entities associated with the financial accounts, addresses associated with the financial accounts, transaction data and/or transaction history associated with the financial accounts, whether one or more financial account are linked to one or more other financial accounts, and/or any other type and/or amount of information. In some embodiments, the account datastore 438 may also store any information relating to providing protection for exceeding the credit threshold and/or for determining authorization decisions for transactions which cause the credit threshold to be exceeded. For example, in some embodiments, the account datastore 438 stores information associated with whether a credit account has protection through a source account and/or whether a holder of a credit account has opted in to a protection service provided by a creditor associated with the credit account, where the protection service provides protection for exceeding the credit threshold. In some embodiments, the account datastore 438 additionally or alternatively stores information associated with online and/or mobile banking.

It will be understood that the account datastore 438 may include any one or more storage devices, including, but not limited to, datastores, databases, and/or any of the other storage devices typically associated with a computer system. It will also be understood that the account datastore 438 may store information in any known way, such as, for example, by using one or more computer codes and/or languages, alphanumeric character strings, data sets, figures, tables, charts, links, documents, and/or the like. Further, in some embodiments, the account datastore 438 may include information associated with one or more applications, such as, for example, the account application 437. It will also be understood that, in some embodiments, the account datastore 438 provides a substantially real-time representation of the information stored therein, so that, for example, when the processor 434 accesses the account datastore 438, the information stored therein is current or substantially current.

It will be understood that the embodiment illustrated in FIG. 4 is exemplary and that other embodiments may vary. For example, in some embodiments, some or all of the portions of the system 400 may be combined into a single portion. Specifically, in some embodiments, the user interface apparatus 420 and the account management apparatus 430 are combined into a single user interface and account management apparatus configured to perform all of the same functions of those separate portions as described and/or contemplated herein. Likewise, in some embodiments, some or all of the portions of the system 400 may be separated into two or more distinct portions. Specifically, in some embodiments, the account management apparatus 430 may be separated into a transaction authorization system configured to determine one or more authorization decisions, and an protection apparatus configured to configure set up protection for exceeding the credit threshold for the credit account 433 through the source account 431, transfer offsetting funds from the source account 431 to the credit account 433, and/or apply service payments to the source account 431 and/or the credit account 433.

In addition, the various portions of the system 400 may be maintained for by the same or separate parties. For example, as previously mentioned, a single financial institution may maintain the source account 431 and the credit account 433, as well as the account management apparatus 430. However, in other embodiments, the accounts and/or the account management apparatus 430 may each be maintained by separate entities.

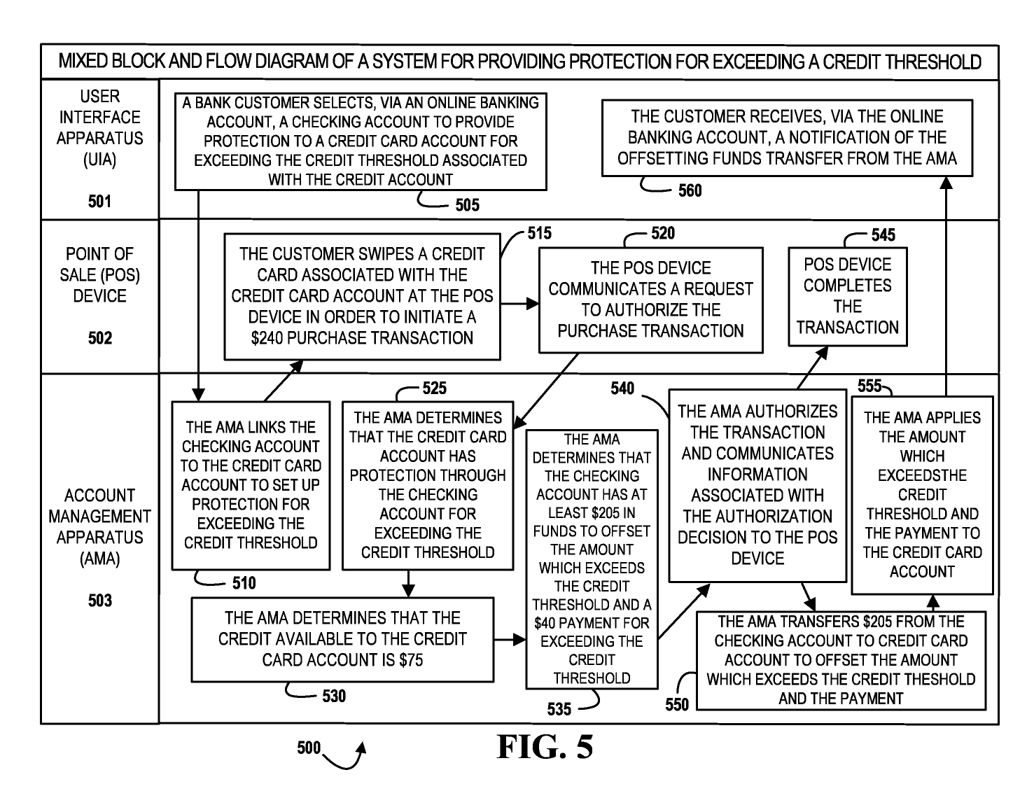

It will also be understood that the system 400 may include and/or implement any one or more portions of any embodiment of the present invention described and/or contemplated herein. More specifically, in some embodiments, the system 400 is configured to implement any one or more portions of the embodiments of the process flow 100 described and/or contemplated herein in connection with FIG. 1, any one or more portions of the embodiments of the process flow 200 described and/or contemplated herein in connection with FIG. 2, any one or more portions of the embodiments of the process flow 300 described and/or contemplated herein in connection with FIG. 3, and/or any one or more portions of the embodiments of the process flow 500 described and/or contemplated herein in connection with FIG. 5.

For example, in some embodiments, the account application 437 is configured to cause the processor 434 of the account management apparatus 430 to: (a) link the source account 431 to the credit account 433, as represented by the block 110 in FIG. 1; (b) determine that the credit account 433 has exceeded, or will exceed the credit threshold as a result of a transaction (e.g., performed at the POS device 440, and the like), as represented by the block 120; (c) transfer funds from the source account 431 to the credit account 433 in an amount sufficient to offset the amount which exceeds the credit threshold, as represented by the block 130; and (d) apply a service payment (e.g., to the source account 431 and/or the credit account 433, and the like), as represented by the block 140. As another example, in some embodiments, the account application 437 is additionally or alternatively configured to cause the processor 434 to: (a) receive a request to authorize a transaction (e.g., the transaction referred to the immediately preceding example, and the like) involving the credit account 433, as represented by the block 210 in FIG. 2; (b) determine that the credit account 433 will exceed the credit threshold as a result of the transaction, as represented by the block 220; and (c) authorize the transaction based at least partially on a determination that the credit account 433 has protection through the source account 431 for exceeding the credit threshold, as represented by the block 230.

Referring now to FIG. 5, a mixed block and flow diagram of a system 500 for providing protection for exceeding the credit threshold is provided, in accordance with a more-detailed embodiment of the present invention. As shown, the system 500 includes a user interface apparatus 501 (e.g., the user interface apparatus 420 in FIG. 4, and the like), a point of sale device 502 (e.g., the point of sale device 440 in FIG. 4, and the like), and an account management apparatus 503 (e.g., the account management apparatus 430 in FIG. 4, and the like). It will be understood that the user interface apparatus 501 and the point of sale device 502 are both operatively and selectively connected to the account management apparatus 503 via a network (not shown). It will also be understood that the user interface apparatus 501 and the point of sale device 502 are accessible to a bank customer (not shown), and that the bank customer holds a checking account and a credit card account that are maintained by the bank (not shown). It will further be understood that the bank provides the customer with access to an online banking account (not shown) for managing and/or otherwise accessing the customer's bank and/or non-bank accounts.

As represented by the block 505, the bank customer selects, via the online banking account, the checking account to provide protection, for exceeding the credit threshold, to the credit card account. As represented by the block 510, the account management apparatus 503 is configured to then link the checking account to the credit card account in order to set up protection for the credit card account through the source account for exceeding the credit threshold. As represented by the block 515, the customer then swipes a credit card associated with the credit card account at the point of sale device 502 in order to initiate a $240 purchase transaction. As represented by the block 520, the point of sale device 502 then communicates a request to authorize the purchase transaction to the account management apparatus 503.

Upon receiving the request, the account management apparatus 503 is configured to determine that the credit card account has protection through the checking account for exceeding the credit threshold, as represented by the block 525. Then, as represented by the block 530, the account management apparatus 503 is configured to determine that the credit available to the credit card account is $75, and then, as represented by the block 535, the account management apparatus 503 is configured to determine that the checking account has at least $205 in funds to offset the amount which exceeds the credit threshold and offset a $40 protection payment for exceeding the credit threshold (i.e., $75−$240=−$165→−$165−$40=−$205→−$205+$205=$0). (It will be understood that these particular numbers are being used by way of example and are in no way limiting on the scope of the present invention.) Thereafter, as represented by the block 540, the account management apparatus 503 is configured to authorize the transaction based at least partially on the determinations represented by the blocks 525 and 530, and then communicate information associated with the authorization decision to the point of sale device 502.

Upon receiving the information associated with the authorization decision, the point of sale device 502 completes the transaction, as represented by the block 545. In addition, after the account management apparatus 503 authorizes the transaction, the account management apparatus 503 is configured to transfer $205 from the checking account to the credit card account in order to offset the amount which exceeds the credit threshold and the payment for exceeding the credit threshold, as represented by the block 550. Thereafter, the account management apparatus 503 is configured to apply the amount by which the available funds or credit threshold is exceeds and the protection payment for exceeding the credit threshold to the credit card account, as represented by the block 555, and then send a notification, via the online banking account, to the bank customer regarding the offsetting funds transfer, as represented by the block 560.

It will be understood that, in accordance with some embodiments, the account management apparatus 503 is configured to perform each of the portions 525-555 in substantially real time while the transaction is pending. It will also be understood that, in accordance with some embodiments, the account management apparatus 503 can be configured to perform each of the portions 525-555 simultaneously, nearly simultaneously, and/or one after the other.

It will further be understood that one or more of the portions of the process flow represented by the blocks 505-560 may be automatically triggered by one or more of the other portions represented by the blocks 505-560. It will also be understood that the embodiment illustrated in FIG. 5 and described herein represents a more-detailed embodiment of the present invention and that other embodiments of the present invention may vary. For example, other embodiments of the present invention may include more, fewer, and/or different types of apparatuses and/or devices. In addition, it will be understood that the order, the number, and/or the content of the portions described in FIG. 5 may be different in other embodiments. It will also be understood that the system 500 may, where possible, include and/or implement any other embodiment of the present invention as described and/or contemplated herein. Likewise, any other embodiment of the present invention described and/or contemplated herein may, where possible, be configured to implement one or more of the portions 505-560.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus comprising:
a communication interface configured to:
receive a request to authorize a transaction involving a credit account;
receive a second request to authorize a second transaction involving a second credit account; and
a computer processing device operatively connected to the communication interface and configured to:
determine that the credit account will exceed a credit threshold associated with the credit account as a result of the transaction;
authorize the transaction based at least partially on (a) a determination that the credit account comprises protection through a source account for exceeding the credit threshold, wherein the credit account is linked to the source account, and (b) a determination that the source account comprises sufficient funds to offset the amount by which the credit threshold is exceeded;
transfer the funds from the source account to the credit account before the amount by which the credit threshold is exceeded is applied to the credit account;
apply a protection service payment to at least one of the source account or the credit account;
determine that the second credit account will a second credit threshold associated with the second credit account as a result of the second transaction;
determine that the second credit account comprises-protection through a second source account for exceeding the second credit threshold; and
decline the second transaction based at least partially on a comparison of a transaction characteristic to a predetermined user-selected parameter.

2. The apparatus of claim 1, wherein the amount by which the credit threshold is exceeded comprises the difference between an amount of one or more responsibilities incurred by the credit account as a result of the transaction and an amount of credit available to the credit account immediately prior to the transaction.

3. The apparatus of claim 1, wherein the source account comprises two or more source accounts, and wherein the computer processing device is configured to transfer funds from the two or more source accounts to the credit account in accordance with one or more user selections.

4. The apparatus of claim 1, wherein the computer processing device is further configured to transfer funds from the source account to the credit account in an amount sufficient to offset the amount by which the credit threshold is exceeded.

5. The apparatus of claim 1, wherein the computer processing device is configured to authorize the transaction based at least partially on: (a) the determination that the credit account comprises protection through the source account for exceeding the credit threshold, and (b) a determination that the source account does not have enough funds to offset the amount by which the credit threshold is exceeded, and (c) a determination that a holder of the credit account has opted into a protection service provided by a creditor associated with the credit account, wherein the protection service provides protection for exceeding the credit threshold.

6. The apparatus of claim 5, wherein the determination that the holder of the credit account has opted in to the protection service is based at least partially on the determination that the credit account holder has elected to permit the creditor associated with the credit card account to:
(a) authorize a transaction involving the credit card account that results in the credit account exceeding the credit threshold, and
(b) apply a protection service payment associated with the transaction to the credit card account, wherein the payment is applied in response authorizing the transaction.

7. The apparatus of claim 5, wherein the protection service is provided in accordance with the CARD Act of 2009.

8. The apparatus of claim 1, wherein the computer processing device is configured to authorize the transaction based at least partially on: (a) the determination that the credit account comprises protection through the source account for exceeding the credit threshold, and (b) a determination that the amount by which the credit threshold is exceeded is less than a predetermined amount.

9. The apparatus of claim 1, wherein the communication interface is further configured to receive a second request to authorize a second transaction involving a second credit account, and wherein the computer processing device is further configured to:
determine that the second credit account will exceed a second credit threshold associated with the second credit account as a result of the second transaction; and
decline the second transaction based at least partially on: (a) a determination that the second credit account comprises protection through a second source account for exceeding the second credit threshold, (b) a determination that the second source account does not have enough funds to offset the amount by which the second credit threshold is exceeded, and (c) a determination that a second holder of the second credit account has not opted in to an protection service provided by a second creditor associated with the second credit account.

10. The apparatus of claim 1, wherein the communication interface is further configured to receive a second request to authorize a second transaction involving a second credit account, and wherein the computer processing device is further configured to:
determine that the second credit account will exceed a second credit threshold associated with the second credit account as a result of the second transaction;
determine that the second credit account comprises protection through a second source account for exceeding the second credit threshold; and
decline the second transaction based at least partially on at least one of: (a) a determination that the amount by which the second credit threshold is exceeded is greater than a predetermined amount, or (b) a determination that the second transaction occurs outside of a predetermined geographic area.

11. The apparatus of claim 1, wherein the computer processing device is further configured to generate a notification regarding the account exceeding the credit threshold, wherein the communication device is further configured to transmit the notification to a device accessible to the consumer while the transaction is still pending, wherein the communication device is further configured to receive a response to the notification, and wherein the computer processing device is further configured to authorize the transaction based at least partially on the response.

12. A method comprising:
providing a non-transitory computer-readable medium comprising computer program code stored thereon, wherein said computer program code is specifically configured to cause one or more computer processing devices to perform the following operations when performing the computer program code:
receiving, via a computer processing device, a request to authorize a transaction involving a credit account;
receiving, via a computer processing device, a second request to authorize a second transaction involving a second credit account;
determining, using a computer processing device, that the credit account will exceed a credit threshold associated with the credit account as a result of the transaction;
authorizing, using a computer processing device, the transaction based at least partially on (a) a determination that the credit account comprises credit account discrepancy protection through a source account for exceeding the credit threshold, wherein the credit account is linked to the source account, and (b) a determination that the source account comprises sufficient funds to offset the account; and
transferring, using a computer processing device, the funds from the source account to the credit account before the amount by which the credit threshold is exceeded is applied to the credit account;
applying, using a computer processing device, a protection service payment to at least one of the source account or the credit account;
determining, using a computer processing device, that the second credit account will exceed a second credit threshold associated with the second credit account as a result of the second transaction;
determining, using a computer processing device, that the second credit account comprises protection through a second source account for exceeding the second credit threshold; and
declining, using a computer processing device, the second transaction based at least partially on a comparison of a transaction characteristic to a predetermined user-selected parameter.

13. The method of claim 12, further comprising:
transferring funds from the source account to the credit account in an amount sufficient to offset the amount by which the credit threshold is exceeded.

14. The method of claim 12, wherein authorizing the transaction further comprises authorizing the transaction based at least partially on: (a) the determination that the credit account comprises protection through a source account for exceeding the credit threshold, (b) a determination that the source account does not have enough funds to offset the amount by which the credit threshold is exceeded, and (c) a determination that a holder of the credit account has opted in to a protection service provided by a creditor associated with the credit account, wherein the protection service provides protection for exceeding the credit threshold.

15. The method of claim 14, wherein the determination that the holder of the credit account has opted in to the protection service is based at least partially on the determination that the credit account holder has elected to permit the creditor associated with the credit card account to:
(a) authorize a transaction involving the credit card account that results in the credit account exceeding the credit threshold, and
(b) apply a protection service payment associated with the transaction to the credit card account, wherein the payment is applied in response authorizing the transaction.

16. The method of claim 14, further comprising:
generating a notification regarding the account exceeding the credit threshold;
transmitting the notification to a device accessible to the consumer while the transaction is still pending; and
receiving a response to the notification,
wherein authorizing the transaction further comprises authorizing the transaction based at least partially on the response.

17. An apparatus comprising:
a communication interface configured to receive requests to authorize transactions, wherein each of the transactions involves a credit account that will exceed a credit threshold associated with the credit account if the transaction is authorized; and
a computer processing device operatively connected to the communication interface and configured to:
authorize a first group of the transactions based at least partially on; (a) a determination that, for each transaction in the first group, the credit account comprises protection through a source account for exceeding the credit threshold, and (b) a determination that, for each transaction in the first group, the source account comprises sufficient funds to offset the account discrepancy;
transfer, for each transaction in the first group, funds from the source account to the credit account before the amount by which the credit threshold is exceeded is applied to the credit account;
apply, for each transaction in the first group, a protection service payment to at least one of the source account or the credit account;
authorize a second group of the transactions based at least partially on a determination that, for each transaction in the second group, the credit account is held by a holder that has opted in to a protection service provided by a creditor associated with the credit account, wherein the protection service provides protection for exceeding the credit threshold; and
decline a third group of the transactions based at least partially on: (a) a determination that, for each transaction in the third group, the credit account does not comprise protection through a source account for exceeding the credit threshold, (b) a determination that, for each transaction in the third group, the credit account is held by a holder that has not opted in to a protection service provided by a creditor associated with the credit account, wherein the protection service provides protection for exceeding the credit threshold, and (c) a comparison of a transaction characteristic to a predetermined a user-selected parameter.

18. The apparatus of claim 17, wherein the computer processing device is further configured to:
for each transaction in the first group, transfer funds from the source account to the credit account in an amount sufficient to offset the amount by which the credit threshold is exceeded.

19. The apparatus of claim 17, wherein the computer processing device is further configured to:
for each transaction in the first group, apply a protection payment to at least one of the source account or the credit account, wherein the payment is applied in response to the credit account exceeding the credit threshold; and
for each transaction in the second group, apply a payment to the credit account, wherein the payment is applied in response to the credit account exceeding the available funds,
wherein the payment applied for each transaction in the second group is greater than the protection payment applied for each transaction in the first group.

20. The apparatus of claim 17, wherein the computer processing device is configured to authorize the second group of the transactions based at least partially on: (a) the determination that, for each transaction in the second group, the credit account is held by a holder that has opted in to a protection service provided by a creditor associated with the credit account, wherein the protection service provides protection for exceeding the credit threshold, (b) a determination that, for each transaction in the second group, the credit account comprises protection through a source account for exceeding the credit threshold, and (c) a determination that, for each transaction in the second group, the source account does not have enough funds to offset the amount by which the credit threshold is exceeded.

21. The apparatus of claim 20, wherein the determination that, for each transaction in the second group, the credit account is held by a holder that has opted in to a protection service is based at least partially on the determination that, for each transaction in the second group, the credit account holder has elected to permit the creditor associated with the credit card account to:
(a) authorize a transaction involving the credit card account that results in the credit account exceeding the credit threshold, and
(b) apply a protection service payment associated with the transaction to the credit card account, wherein the payment is applied in response authorizing the transaction.

22. The apparatus of claim 21, wherein the protection service is provided in accordance with the CARD Act of 2009.

23. The apparatus of claim 21, wherein the computer processing device is further configured to:
decline a fourth group of the transactions based at least partially on: (a) a determination that, for each transaction in the fourth group, the credit account comprises protection through a source account for exceeding the credit threshold, (b) a determination that, for each transaction in the fourth group, the source account does not have enough funds to offset the amount by which the credit threshold is exceeded, and (c) a determination that, for each transaction in the fourth group, the credit account is held by a holder that has not opted in to a protection service provided by a creditor associated with the credit account, wherein the protection service provides protection for exceeding the credit threshold.

24. A method comprising:
providing a non-transitory computer-readable medium comprising computer program code stored thereon, wherein said computer program code is specifically configured to cause one or more computer processing devices to perform the following operations when performing the computer program code:
receiving, via a computer processing device, requests to authorize transactions, wherein each of the transactions involves a credit account that will exceed a credit threshold associated with the credit account if the transaction is authorized;
authorizing, using a computer processing device, a first group of the transactions based at least partially on (a) a determination that, for each transaction in the first group, the credit account protection through a source account for exceeding the credit threshold, and (b) a determination that, for each transaction in the first group, the source account comprises sufficient funds to offset the amount by which the credit threshold is exceeded;
transferring, using a computer processing device, for each transaction in the first group, funds from the source account to the credit account before the amount by which the credit threshold is exceeded is applied to the credit account;
applying, using a computer processing device, for each transaction in the first group, a protection service payment to at least one of the source account or the credit account;
authorizing, using a computer processing device, a second group of the transactions based at least partially on a determination that, for each transaction in the second group, the credit account is held by a holder that has opted in to a protection service provided by a creditor associated with the credit account, wherein the protection service provides protection for exceeding the credit threshold; and
declining, using a computer processing device, a third group of the transactions based at least partially on: (a) a determination that, for each transaction in the third group, the credit account does not protection through a source account for exceeding the credit threshold, (b) a determination that, for each transaction in the third group, the credit account is held by a holder that has not opted in to a protection service provided by a creditor associated with the credit account, wherein the protection service provides protection for exceeding the credit threshold, and (c) a comparison of a transaction characteristic to a predetermined user-selected parameter.

25. The method of claim 25, further comprising:
for each transaction in the first group, transferring funds from the source account to the credit account in an amount sufficient to offset the amount by which the credit threshold is exceeded.

26. The method of claim 25, further comprising:
for each transaction in the first group, applying a protection payment to at least one of the source account or the credit account, wherein the payment is applied in response to the credit account exceeding the credit threshold; and
for each transaction in the second group, applying a payment to the credit account, wherein the payment is applied in response to the credit account exceeding the available funds,
wherein the payment applied for each transaction in the second is greater than the protection payment applied for each transaction in the first group.

27. The method of claim 25, wherein authorizing the second group of the transactions comprises authorizing the second group of the transactions based at least partially on: (a) the determination that, for each transaction in the second group, the credit account is held by a holder that has opted in to a protection service provided by a creditor associated with the credit account, wherein the protection service provides protection for exceeding the credit threshold, (b) a determination that, for each transaction in the second group, the credit account comprises protection through the source account for exceeding the credit threshold, and (c) a determination that, for each transaction in the second group, the source account does not have enough funds to offset the amount by which the credit threshold is exceeded.

28. The method of claim 27, wherein the determination that, for each transaction in the second group, the credit account is held by a holder that has opted in to a protection service is based at least partially on the determination that, for each transaction in the second group, the credit account holder has elected to permit the creditor associated with the credit card account to:
(a) authorize a transaction involving the credit card account that results in the credit account exceeding the credit threshold, and
(b) apply a protection service payment associated with the transaction to the credit card account, wherein the payment is applied in response authorizing the transaction.

29. The method of claim 25, further comprising:
declining a fourth group of the transactions based at least partially on: (a) a determination that, for each transaction in the fourth group, the credit account comprises protection through a source account for exceeding the credit threshold, (b) a determination that, for each transaction in the fourth group, the source account does not have enough funds to offset the amount by which the credit threshold is exceeded, and (c) a determination that, for each transaction in the fourth group, the credit account is held by a holder that has not opted in to a protection service provided by a creditor associated with the credit account, wherein the protection service provides protection for exceeding the credit threshold.

30. A computer program product comprising a non-transitory computer-readable medium, wherein the computer-readable medium comprises computer-executable program code portions stored therein, wherein the computer-executable program code portions comprise:
a first program code portion configured to receive requests to authorize transactions, wherein each of the transactions involves a credit account that will exceed a credit threshold associated with the credit account if the transaction is authorized;
a second program code portion configured to authorize a first group of the transactions based at least partially on (a) a determination that, for each transaction in the first group, the credit account comprises protection through a source account for exceeding the credit threshold, and (b) a determination that, for each transaction in the first group, the source account comprises sufficient funds to offset the amount by which the credit threshold is exceeded;
a third program code portion configured to transfer, for each transaction in the first group, funds from the source account to the credit account before the amount by which the credit threshold is exceeded is applied to the credit account;
a fourth program code portion configured to apply, for each transaction in the first group, a protection service payment to at least one of the source account or the credit account;
a fifth program code portion configured to authorize a second group of the transactions based at least partially on a determination that, for each transaction in the second group, the credit account is held by a holder that has opted in to a protection service provided by a creditor associated with the credit account, wherein the protection service provides protection for exceeding the credit threshold; and
a sixth program code portion configured to decline a third group of the transactions based at least partially on a determination that, for each transaction in the third group, the credit account: (a) does not comprise protection through the source account for exceeding the credit threshold, (b) is held by a holder that has not opted in to a protection service provided by a creditor associated with the credit account, wherein the protection service provides protection for exceeding the credit threshold, and (c) a comparison of a transaction characteristic to a predetermined user-selected parameter.

31. The computer program product of claim 30, further comprising:
a seventh program code portion configured to, for each transaction in the first group, transfer funds from the source account to the credit account in an amount sufficient to offset the account discrepancy.

32. The computer program product of claim 30, further comprising:
a seventh program code portion configured to, for each transaction in the first group, apply a protection payment to at least one of the source account or the credit account, wherein the payment is applied in response to the credit account exceeding the credit threshold; and
an eighth program code portion configured to, for each transaction in the second group, apply a payment to the credit account, wherein the payment is applied in response to the credit account exceeding the available funds,
wherein the payment applied for each transaction in the second group is greater than the protection payment applied for each transaction in the first group.
